(19) United States
(12) Patent Application Publication
(10) Pub. No.: US 2015/0113483 A1
(43) Pub. Date: Apr. 23, 2015

(54) Method for Human-Computer Interaction on a Graphical User Interface (GUI)

(71) Applicant: Willem Morkel VAN DER WESTHUIZEN, STELLENBOSCH (ZA)

(72) Inventors: Willem Morkel Van Der Westhuizen, Stellenbosch (ZA); Filippus Lourens Andries Du Plessis, Stellenbosch (ZA); Hendrik Frans Verwoerd Boshoff, Stellenbosch (ZA); Jan Pool, Stellenbosch (ZA)

(21) Appl. No.: 14/361,423

(22) PCT Filed: Sep. 21, 2012
(86) PCT No.: PCT/ZA2012/000059

§ 371 Date: May 29, 2014

(30) Foreign Application Priority Data
Sep. 30, 2011 (ZA) 2011/07169
Sep. 30, 2011 (ZA) 2011/07170
Sep. 30, 2011 (ZA) 2011/07171
Sep. 30, 2011 (ZA) 2011/07172

(51) Int. Cl. G06F 3/0484; G06F 3/0481

(52) U.S. Cl. CPC G06F 3/04842; G06F 3/04815
USPC 715/850; 715/862

(57) ABSTRACT

The invention provides a method for human-computer interaction on a graphical user interface (GUI), a GUI, a navigation tool, computers and computer operated devices. The method includes the steps of: determining coordinates of a pointer with, or relative, to an input device; determining coordinates of interactive objects of which at least two objects are displayed; establishing a threshold in relation to the interactive objects and in relation to space about them; prioritizing the interactive objects in relation to their distance and/or direction to the pointer; moving the interactive objects and thresholds relative to the object priority; repeating the above steps every time the coordinates of the pointer changes; and performing an action when a threshold is reached.

### TECHNICAL FIELD OF THE INVENTION

This invention relates to human-computer interaction. More specifically, the invention relates to a method for human-computer interaction on a graphical user interface (GUI), a navigation tool, computers and computer operated devices, which include such interfaces and tools.

### BACKGROUND TO THE INVENTION

In human-computer interaction (HCl) the graphical user interface (GUI) has supported the development of a simple but effective graphical language. A continuous control device, such as a mouse or track pad, and a display device, such as a screen, are used to combine the user and the computer into a single joint cognitive system. The computer provides the user with graphical feedback to control movements made relative to visual representations of abstract collections of information, called objects. What the user does to an object in the interface is called an action.

The user may assume the role of consumer and/or creator of content, including music, video and text or a mixture of these, which may appear on web pages, in video conferencing, or games. The user may, alternatively join forces with the computer to control a real world production plant, machine, apparatus or process, such as a plastics injection moulding factory, an irrigation system or a vehicle.

The GUI is an object-action interface, in which an object is identified and an action is performed on it, in that sequence. Objects are represented in a space where they can be seen and directly manipulated. This space is often modelled after a desktop.

The graphical elements of the GUI are collectively called WIMP, which stands for windows, icons, menus and pointer. These objects may be analysed as follows:
The pointer, or cursor, represents the user in the interface, and is moved around on the display to points of interest. It may have various shapes in different contexts, but it is designed to indicate a single point in space at every instant in time.
The icons represent computer internal objects, including media files and programs, and real world entities such as people, other computers and properties of a plant. Icons relieve the user from having to remember names or labels, but they compete with each other for the limited display space.
Windows and menus both address the problem of organizing user interaction with a large number of icons and other content using the finite display space. Windows allow the reuse of all or parts of the display through managed overlap, and they may also contain other windows. In this sense, they represent the interface in the interface, recursively.
The utility of menus consists in hiding their contents behind a label unless called on to reveal it, at which point they drop down, and temporarily cover, part of the current window. A different approach lets the menu pop up, on demand, at the location of the pointer. In the last case, the menu contents typically varies with the context. Menu contents is an orderly arrangement of icons, mostly displayed vertically and often in the form of text labels.

As the available display space increased due to technological developments, variants of the menu appeared in the GUI. In these new style menus, important and frequently used objects and actions are not hidden, but are persistently made visible as small, mostly graphical icons. They are generally displayed horizontally and have been called bars, panels, docks or ribbons. Radial or pie menus have also been developed, based on a circular geometry, especially for the pop up case.

The problem of a finite display space does not end with finding ways to access more icons. For example, document size easily exceeds the available space, therefore virtual variants on the age old solutions of paging and scrolling were incorporated in GUI's early on. The somewhat more general but still linear methods of zooming and panning have also been adapted, especially in the presentation of graphical content. Within the information visualization environment, distortion based displays such as lensing have been applied, as well as context+focus techniques and generalized fish-eye views, based on degree-of-interest functions.

In the graphical language of the GUI, icons may be regarded as atoms of meaning comparable to nouns in speech. Control actions similarly correspond to verbs, and simple graphical object-action sentences may be constructed via the elementary syntax of pointing and clicking. Pointing is achieved by moving a mouse or similar device and it has the effect of moving the pointer on the display.

Clicking is actually a compound action and on a mouse it consists of closing a switch (button down) and opening it again (button up) without appreciable pointing movement in between. If there is significant movement, it may be interpreted by the interface as the dragging of an object, or the selection of a rectangular part of the display space or its contents. Extensions of these actions include double clicking and right-clicking.

On the simple basis of the four WIMP object types and point & click actions, the original GUI has been applied to a wide variety of tasks, which found a large and global user base. Despite this success and constant innovation over more than three decades, many challenges remain.

Efficiency is of great concern, and some GUI operations still require many repetitions of point and click to accomplish relatively simple conceptual tasks, such as selecting a file or changing the properties of text. In the case where the user has already made a mental choice and only has to communicate this to the computer, the forced traversal of space, like navigation of a file system or toolset hierarchy, may be slow and frustrating. This is a direct result of having to divide every user operation into small steps, each fitting the GUI syntax.

One of the biggest drawbacks of the GUI and its derivatives relates to the fact that pointing actions are substantially ignored until the user clicks. During interaction, the computer should ideally respond to the relevant and possibly changing intentional states in the mind of the user. While these states are not directly detectable, some aspects of user movement may be tracked to infer them. Only two states are implicitly modelled in GUI interaction: interest and certainty.

In the point and click interface the user sometimes signals interest by pointing to an object and always signals certainty by clicking. Interest can only sometimes be inferred from pointing, because at other times the pointer passes over regions of non-interest on its way to the interesting ones. This ambiguity about pointing is overcome by having the computer respond mainly to clicking. Pointing is interpreted as definite interest only when clicking indicates certainty. The GUI thus works with binary levels for each of interest and certainty, in a hierarchical way, where certainty is required before interest is even considered.

Typical GUI interaction is therefore a discontinuous procedure, where the information rate peaks to a very high value right after clicking, as in the sudden opening of a new window. This could result in a disorienting user experience. Animations have been introduced to soften this effect, but once set in motion, they cannot be reversed. Animations in the GUI are not controlled movements, only visual orientation aids.

A better interface response to pointing may be achieved by positively utilizing the space separating the cursor from the icons, instead of approaching it as an obstacle. Changes in object size as a function of relative cursor distance have been introduced to GUIs, and the effect may be compared to lensing. Once two objects overlap, however, simple magnification will not separate them.

Advances have been made to improve the speed and ease of use of the GUI. U.S. Pat. No. 7,434,177 describes a tool for a graphical user interface, which permits a greater number of objects to reside, and be simultaneously displayed, in the userbar and which claims to provide greater access to those objects. It does this by providing for a row of abutting objects and magnifying the objects in relation to each object's distance from the pointer when the pointer is positioned over the row of abutting objects. In other words, the magnification of a particular object depends on the lateral distance of the pointer from a side edge of that object, when the pointer is positioned over the row. This invention can therefore be described as a visualising tool.

PCT/FI2006/050054 describes a GUI selector tool, which divide up an area about a central point into sectors in a pie menu configuration. Some or all of the sectors are scaled in relation to its relative distance to a pointer. It seems that distance is measured by means of an angle and the tool allows circumferential scrolling. Scaling can be enlarging or shrinking of the sector. The whole enlarged area seems to be selectable and therefore provides a motor advantage to the user. The problem this invention wishes to solve appears to be increasing the number of selectable objects represented on a small screen such as a handheld device. It has been applied to a Twitter interface called Twheel.

A similar selector tool is described in U.S. Pat. No. 6,073,036. This patent discloses a method wherein one symbol of a plurality of symbols are magnified proximate a tactile input to both increase visualisation and to enlarge the input area.

The inventor is further aware of input devices such a touchpads that make use of proximity sensors to sense the presence or proximity of an object such as a finger of a person from or close to the touchpad. For example: US2010/0107099; US2008/0122798; U.S. Pat. No. 7,653,883; and U.S. Pat. No. 7,856,883.

Furnas (1982, 1986) introduced the generalised fish-eye view based on a degree-of-interest function. This function is partially based on the distance between the user cursor and the objects. Sarkar and Brown (1992) expand on this concept to display planar graphs including maps.

A whole range of zoomable user interfaces (ZUI) have been proposed to address the problem of finite display space:
Perlin and Fox (1993) introduced the Pad, an infinite two dimensional information plane shared between users, with objects organized geographically and accessed via “portals.” These can be employed recursively. They also define the idea of semantic zooming, where what is visible of an object radically depends on the size available for its display.
Bederson and Hollan (1994) called their improvement Pad++. They stated that they wanted to go beyond WIMP interfaces, while viewing “interface design as the development of a physics of appearance and behaviour for collections of informational objects”, rather than development of an extended metaphor taken from some aspect of reality such as the desktop.
Appert and Fekete (2006) introduced the “OrthoZoom Scroller” which allows target acquisition in very large one dimensional space by controlling panning and zooming via two orthogonal dimensions. In another article (also 2006) they disclose “ControlTree,” an “interface using crossing interaction to navigate and select nodes in a large tree.”
Dachselt et al (2008) “introduces FacetZoom, a novel multi-scale widget combining facet browsing with zoomable user interfaces. Hierarchical facets are displayed as space-filling widgets which allow a fast traversal across all levels while simultaneously maintaining context.”
Cockburn et al (2007) reviewed ZUIs along with Overview+Detail and Focus+Context interfaces and provided a summary of the state of the art.
Ward et al (2000) introduced “Dasher,” a text entry interface using continuous gestures. The user controls speed and direction of navigation through a space showing likely completions of the current text string with larger size than unlikely ones.

Consideration of Fitts' Law (Fitts, 1954) and many studies based on it, has resulted in the placement of menus on the edge of the display instead of on the associated window, and in enlarging the likely target icons on approach by the pointer.

Many investigators realised that the synthetic world of the GUI does not have to obey physical law. For example, the same object may be represented in more than one place at once in virtual space. Objects may also be given the properties of agents which respond to user actions. Balakrishnan (2004) reviewed a range of attempts at “beating” Fitts' Law by decreasing target distance D (using pie menus, temporarily bringing potential targets closer, removing empty space between cursor and targets), increasing target width W (area cursor, expanding targets, even at a late stage) and changing both D and W (dynamically changing control-display gain, called semantic pointing). They conclude that “[t]he survey suggests that while the techniques developed to date are promising, particularly when applied to the selection of single isolated targets, many of them do not scale well to the common situation in graphical user interfaces where multiple targets are located in close proximity.”

Samp & Decker (2010) experimentally measure and compare visual search time and pointing time using linear and radial menus, and broadly find that a search is easier with linear menus and pointing is easier with radial menus. They also introduce the compact radial layout (CRL) menu as a hierarchical menu with desirable properties with respect to both expert and novice users.

Most of the approaches mentioned above focus on the visualization part of the interaction. This may be advantageous under certain conditions, but efficiency also crucially depends on ease of control, which is a different matter entirely. It relates to human motor control and the allocation of control space to certain actions, instead of allocating display space to their visual representations. Dynamic reallocation of control space is part of semantic pointing, which is based on pre-determined (a priori) priorities and some other time-based schemes like that of Twheel.

So there remains a need for an improved method for human-computer interaction, this interaction would allow intuitive and efficient navigation of an information space and selection of one among a large number of eligible objects, which will empower users to meet their objectives relating to content consumption and creation. It is therefore an object of this invention to design a GUI that affords the user a fluid and continuous interaction in a tight control loop, easily reversed until reaching a threshold, where the interaction is based on priorities signalled by the user as soon as they may be detected, and which provides the advantages of dynamic visualization and dynamic motor control.

### GENERAL DESCRIPTION OF THE INVENTION

According to the invention there is provided a method for human-computer interaction on a graphical user interface (GUI), the method including the steps of:
determining coordinates of a pointer with, or relative, to an input device;
determining coordinates of interactive objects of which at least two objects are displayed;
establishing a threshold in relation to the interactive objects and in relation to space about them;
prioritising the interactive objects in relation to their distance and/or direction to the pointer;
moving the interactive objects and thresholds relative to the object priority;
repeating the above steps every time the coordinates of the pointer changes; and
performing an action when a threshold is reached.

The priority of an interactive object may, for example, be a continuous value between 0 and 1, where 0 is the lowest and 1 is the highest priority value. The priority may, for example, also be discrete values or any other ranking method.

The highest priority may be given to the interactive object closest to the pointer and the lowest priority to the furthest.

When the new coordinates are calculated for the interactive objects, the highest priority interactive objects may be moved closer to the pointer and vice versa. Some of the objects may cooperate with the user, while other objects may act evasively.

In addition to, or instead of, moving, the interactive objects may be sized relative to their priority.

The lower priority objects may be moved away from the higher priority objects and/or the pointer according to each object's priority. Some of the objects may cooperate with each other, while other objects may act evasively by avoiding each other and be moved accordingly.

The method may further include the step of first fixing or determining a reference point for the pointer, from which further changes in the coordinates are referenced.

The method may further include the step of resetting or repositioning the pointer reference point.

The pointer reference point may be reset or may be repositioned as a new starting point for the pointer for further navigation when the edge of a display space is reached, or when a threshold is reached. In some embodiments, the reference point may also be reset or repositioned by a user such as when a pointer object is lifted from a touch sensitive input device.

The initial coordinates of the objects may be in accordance with a data structure or in accordance with weight assigned to each object according to its prior relative importance and the method may include the step of determining the coordinates of the interactive objects relative to each other.

The step of determining the coordinates of interactive objects displayed on the GUI may include the step of determining the coordinates of the interactive objects relative to each other.

The coordinate system may be selected from a Cartesian coordinate system, such as x, y coordinates, or a polar coordinate system. It will be appreciated that there are relationships between coordinate systems and it is possible to transform from one coordinate system to another.

The method may include the step of arranging the objects such that every direction from the pointer may point at not more than one object's position coordinates. Each object may be pointed at from the pointer by a range of angles. Reference is made to the examples where the objects are arranged in a circle or on a line.

Distances and/or directions may be determined from the pointer or the pointer reference to the coordinates of an object.

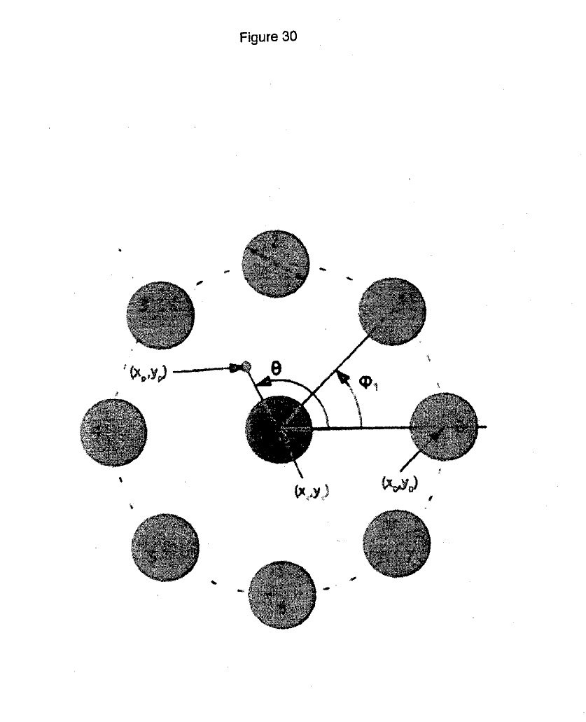

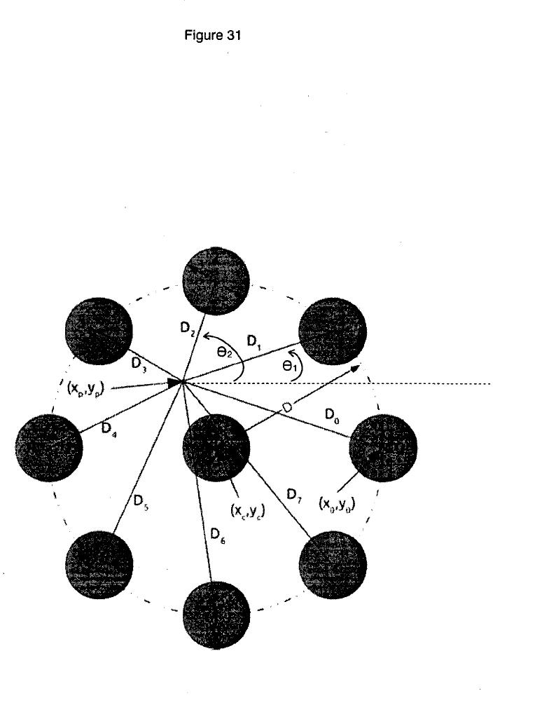

From the pointer or the pointer reference, directional and/or distance measurements to an object can be used as a parameter in an algorithm to determine priority. The directional and distance measurement may respectively be angular and radial. Reference is made to an example of geometry that can be used, FIGS. 30 and 31.

The method may also include the step of recording the movements of the pointer. Historic movements of the pointer are the trajectory, also called the mapping line. The trajectory can be used to determine the intended direction and/or speed of the pointer and/or time derivatives thereof, which may be used as a parameter for determining the priority of the interactive objects. It will be appreciated that the trajectory can also be used to determine input that relates to the prioritised object or objects.

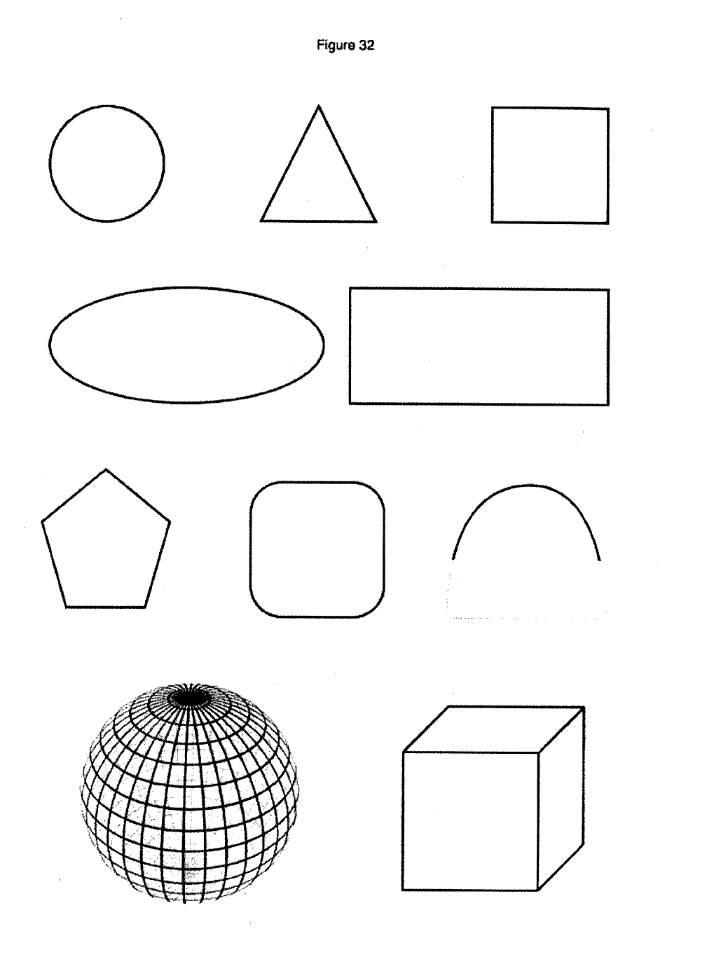

It will be appreciated that an arrangement of objects in a circle about the pointer is an arrangement of objects on the boundary of a convex space. It will further be appreciated that there are a number of convex spaces, which may be used, for example circles, rectangles and triangles. Objects may be arranged on a segment of the boundary, for example arcs or line segments. Reference is made to FIG. 32.

It is an important advantage of the invention to enable separate use of distance and direction to an object to determine independent effects for position, size, state and the like of the object. For example, distance may determine size of an object and direction may determine the position of the object.

Four different types of thresholds may be defined. One may be a threshold related to an object, typically established on the boundary of the object. Another threshold may be associated with space about an object typically along the shortest line between objects. A third type of threshold may be fixed in relation to the pointer reference point. A fourth type of threshold may be established in time, when the pointer coordinates remain static within certain spatial limits for a predetermined time. It can be said that the pointer is “hovering” at those coordinates.

A threshold related to an object can be pierced when reached. In this case the object can be selected or any other input or command related to the object can be triggered. A threshold associated with space about an object can be activated when reached, to display further interactive objects belonging logically in the space around the object.

A plurality of thresholds may be established with regard to each object and with regard to the space about the objects.

A pointer visual representation may be changed when a threshold is reached.

A displayed background may be changed when a threshold is reached.

A visual representation of an object may be changed when a threshold is reached.

It will be appreciated that, similar to the interactive objects, the position and/or shape of the thresholds may also be changed dynamically in association with the interactive objects and relative to each other.

The state or purpose of an object may change in relation to the position of a pointer. In this case, for example, an icon may transform to a window and vice versa in relation to a pointer. This embodiment will be useful for navigation to an object and to determine which action to be performed on the object during navigation to that object.

It should further be appreciated that the invention allows for dynamic hierarchical navigation and interaction with an object before a pointer reaches that object. In addition, the invention allows navigation without selection of an object.

In the case of a semi-circle or a segment of a semi-circle, it will be appreciated that such a geometry combined with the GUI described above would make navigation on handheld devices possible with the same hand holding the device, while providing for a large number of navigational options and interactions. In addition, such an arrangement can limit the area on a touch sensitive screen obscured by a user's hand to a bottom or other convenient edge part of the screen. Once an action is completed the user starts again from the reference point thereby avoiding screen occlusion. In this case a pointer reference or starting point coordinate may be assigned to a pointer and once a threshold has been activated the reference point may become a new starting point for the objects of the next stage of navigation.

It will be appreciated that the invention also relates to a navigation tool that provides for dynamic navigation by improving visualisation and selectability of interactive objects.

Interaction with objects is possible whether displayed or not.

The method may include the step of determining coordinates of more than one pointer. The method may then include the step of establishing a relation between the pointers.

The representation of a pointer may be displayed on the GUI when the input device is not also the display. The method may therefore include displaying a representation of a pointer on the GUI to serve as a reference on the display.

The size calculation and/or change of coordinates of the interactive objects in response to the position and/or movement of the pointer may be a function that is linear, exponential, power, hyperbolic, heuristic, a multi-part function or combination thereof. The function may be configured to be user adjustable.

The method may include a threshold associated with space about an object to be activated to establish new interactive objects belonging logically in or behind space between existing interactive objects. For example, objects which logically belong between existing interactive objects can then be established when the existing objects have been moved and resized to provide more space to allow for the new objects. The new object(s) may grow from non-visible to comparable interactive objects to create the effect of navigating through space and/or into levels beyond the existing objects. It will further be appreciated that the new objects can react the same as the existing objects, as described above with regard to movement and sizing. Once a threshold is reached, interaction may start again from a new pointer reference point.

According to another aspect of the invention there is provided a method for human-computer interaction on a graphical user interface (GUI), the method including the steps of:
determining coordinates of a pointer;
arranging interactive objects in a convex collection configuration relative to the pointer or a centre point;
displaying one or more of the interactive objects in the convex collection;
determining coordinates of the interactive objects displayed on the GUI relative to the coordinates of the pointer;
prioritising the interactive objects in relation to their distance to the pointer; moving the interactive objects relative to their priority; and repeating the above steps every time the coordinates of the pointer changes.

The method may further include the steps of:

determining interaction coordinates of interactive objects;
determining display coordinates of interactive objects of which at least two objects are displayed.

The method may include the step of arranging the objects such that every direction from the pointer may point at not more than one object's interaction coordinate. Each object may be pointed at from the pointer by a range of angles. Reference is made to the examples where the objects are arranged in a circle or line.

It should be appreciated that the interaction coordinates of an object may be different from the object's display coordinates. For example, interaction coordinates may be used in a function or algorithm to determine the display coordinates of an object. It should then also be appreciated that the interaction coordinates can be arranged to provide a functional advantage, such as arrangement of object interaction coordinates on the boundary of a convex space as discussed below, and the display coordinates can be arranged to provide a visual advantage to the user.

Distances and/or directions may be determined from the pointer or the pointer reference to the interaction or the display coordinates of an object.

When the new interaction coordinates are calculated for the interactive objects, the highest priority interactive objects may be moved closer to the pointer and/or assigned a bigger size and vice versa.

The initial interaction coordinates of the objects may be in accordance with a data structure or in accordance with weight assigned to each object according to its prior relative importance and the method may include the step of determining the interaction coordinates of the interactive objects relative to each other.

The step of determining the interaction coordinates of interactive objects displayed on the GUI may include the step of determining the interaction coordinates of the interactive objects relative to each other.

From the pointer or the pointer reference, directional and/or distance measurements to an interaction coordinate can be used as a parameter in an algorithm to determine priority of an object. The directional and distance measurement may respectively be angular and radial.

It will be appreciated that an arrangement of object interaction coordinates in a circle about the pointer is an arrangement of object interaction coordinates on the boundary of a convex space. It will further be appreciated that there are a number of convex spaces that may be used, for example circles, rectangles and triangles. Objects may be arranged on a segment of the boundary, for example arcs or line segments. Reference is made to FIG. 32.

It is an important advantage of the invention to enable separate use of distance and direction to an object's interaction coordinate to determine independent effects for position, size, state and the like of the object. For example, distance may determine size of an object and direction may determine the position of the object.

In the case where the interaction coordinate and the display coordinate are separated, two additional types of thresholds may be defined. One may be a threshold related to an object's interaction coordinate. Another threshold may be associated with space about an object's interaction coordinate typically along the shortest line between interaction coordinates.

A threshold related to an object's interaction coordinates can be pierced when reached. In this case an object can be selected or any other input or command related to the object can be triggered. A threshold associated with space about an object's interaction coordinate can be activated when reached, to display further interactive objects belonging logically in the space around the object's interaction coordinates.

A plurality of thresholds may be established with regard to each object's interaction coordinates and with regard to the space about objects' interaction coordinates.

It should further be appreciated that the invention allows for dynamic hierarchical navigation and interaction with an object's interaction coordinates before a pointer reaches the interaction coordinates.

Interaction with objects' interaction coordinates is possible whether the objects are displayed or not.

The movement of interaction coordinates of the objects in response to the position and/or movement of the pointer may be a function that is linear, exponential, power, hyperbolic, heuristic or combination thereof.

The method may include a threshold associated with space about an object's interaction coordinates to be activated to establish new interactive objects belonging logically in or behind space between existing objects' interaction coordinates. For example, objects which logically belong between existing objects can then be established when the existing objects have been moved and resized to provide more space to allow for the new objects. The new object(s) may grow from non-visible to comparable interactive objects to create the effect of navigating through space and/or into levels beyond the existing objects. It will further be appreciated that the new objects can react the same as the existing objects, as described above with regard to movement and sizing. Once a threshold is reached, interaction may start again from a new pointer reference point.

In one embodiment of the invention, the coordinate system may be selected from a three-dimensional Cartesian coordinate system, such as x, y, z coordinates, or a polar coordinate system. It will be appreciated that there are relationships between coordinate systems and it is possible to transform from one coordinate system to another. The method may also include the steps of assigning a virtual z coordinate value to the interactive objects displayed on the GUI, to create a virtual three-dimensional GUI space extending behind and/or above the display.

The method may then also include the steps of:

assigning a virtual z coordinate value to the interactive objects displayed on the GUI, to create a virtual three-dimensional GUI space extending behind and/or above the display; and
determining a corresponding virtual z coordinate value relative to the distance, Z, of a pointer object above the input device.

It will be appreciated that a threshold related to an object arranged in a plane may be established as a three-dimensional boundary of the object. One threshold may be linked with a plane associated with space about an object typically perpendicular along the shortest line between objects. Another threshold may be in relation to the pointer reference point such as a predetermined distance from the reference point in three-dimensional space. In addition, the method may include the step of establishing a threshold related to the z coordinate value in the z-axis. The Z coordinate of a pointer object may then be related to this threshold.

The virtual z coordinate values may include both positive and negative values along the z-axis. Positive virtual z coordinate values can be used to define space above the surface of the display and negative virtual z coordinate values can be used to define space below (into or behind) the surface, the space being virtual, for example. A threshold plane may then be defined along the Z-axis for the input device, which may represent the surface of the display. The value of the z coordinate above the threshold plane is represented with positive z values and the value below the threshold plane represents negative z values. It will be appreciated that, by default, the z coordinate value of the display will be assigned a zero value, which corresponds to a zero z value of the threshold plane.

After a virtual threshold plane is activated or pierced, a new virtual threshold plane can be established by hovering the pointer for a predetermined time. It will be appreciated that this may just be one way of successive navigation deeper into the GUI display, i.e. into higher negative z values.

In another embodiment of the invention, a hovering pointer object, in other words where a pointer object is at or near a certain Z value for a predetermined time, the method may include establishing a horizontal virtual threshold plane at the corresponding virtual z coordinate value which may represent the surface of the display. Then, when the x, y coordinate of the pointer approaches or is proximate space between interactive objects displayed on the GUI, a threshold will be activated. If the pointer's x, y coordinates correspond to the x, y coordinates of an interactive object, which is then approached in the z-axis by the pointer object, the threshold is pierced and the object can be selected by touching the touchpad or clicking a pointer device such a mouse.

The method may include providing a plurality of virtual threshold planes along the z-axis, each providing a plane in which to arrange interactive objects in the GUI, with preferably only the objects in one plane visible at any one time, particularly on a two-dimensional display. On a two-dimensional display interactive objects on other planes having a more negative z coordinate value than the objects being displayed may be invisible, transparent or alternatively greyed out or veiled. More positive z valued interactive objects will naturally not be visible. On a three-dimensional display, interactive objects on additional threshold planes may be visible. It will be appreciated that this feature of the invention is useful for navigating on a GUI.

The threshold along the z-axis may be changed dynamically and/or may include a zeroing mechanism to allow a user to navigate into a plurality of zeroed threshold planes.

In one embodiment of the invention, the virtual z value of the surface of the display and the Z value of the horizontal imaginary threshold, may have corresponding values in the case where the display surface represents a horizontal threshold, or other non-corresponding values, where it does not. It will be appreciated that the latter will be useful for interaction with a GUI displayed on a three-dimensional graphical display, where the surface of the display itself may not be visible and interactive objects appear in front and behind the actual surface of the display.

The visual representation of the pointer may be changed according to its position along the z-axis, Z-axis or its position relative to a threshold.

The method may include the step of determining the orientation or change of orientation of the pointer object above an independent, fixed or stationary x, y coordinates in terms of its x, y and Z coordinates. In the case of a mouse pointing device, the mouse may determine the x, y coordinates and the position of a pointer object above the mouse button may determine independent x, y and Z coordinates. In the case of a touch sensitive input device, the x, y coordinates can be fixed, by clicking a button for example, from which the orientation can be determined. It should be appreciated that this would be one way of reaching or navigating behind or around an item in a virtual three-dimensional GUI space. It will also be appreciated that orientation of the x-axis can, for example simulate a joystick, which can be used to navigate three-dimensional virtual graphics, such as computer games, flight simulators, machine controls and the like. In this case, it will also be appreciated that the x, y, z coordinates of the pointer object above the fixed x, y coordinates will vary. A fixed pointer can then be displayed and a moveable pointer can be displayed. A line connecting the fixed pointer and the moveable pointer can be displayed, to simulate a joystick.

According to another aspect of the invention there is provided a method for human-computer interaction on a graphical user interface (GUI), the method including the steps of:
referencing a point in a virtual space at which a user is navigating at a point in time, called the pointer;
referencing points in the virtual space;
calculating interaction of the points in the virtual space with the pointer in the virtual space according to an algorithm whereby the distance between points closer to the pointer is reduced;
establishing a threshold in relation to the referencing points and in relation to space about them;
moving and/or sizing reference point thresholds according to an algorithm in relation to the distance between the reference point and the pointer;
repeating the above steps every time the coordinates of the pointer changes; and
performing an action when a threshold is reached.

In other words, the algorithm causes the virtual plane and space to be contracted with regard to closer reference points and expanded with regard to more distant reference points. The contraction and expansion of the space can be graphically represented to provide a visual aid to a user of the GUI.

At one or more of the referenced points in the virtual space further characteristics may be assigned to act as a cooperative target or cooperative beacon. The cooperative target or cooperative beacon may be interactive and will then be an interactive object, as described earlier in this specification. Such further referenced targets or beacons may be graphically displayed on a display of a computer. Such targets or beacons may be displayed as a function of an algorithm.

Interaction of referenced points or target points or beacon points with the pointer point may be according to another algorithm for calculating interaction between the non-assigned points in the virtual space.

The algorithms may also include a function to increase the size or interaction zone together with the graphical representation thereof when the distance between the pointer and the target or beacon is decreased and vice versa.

Points in the space can be referenced (activated) as a function of an algorithm.

Points in the virtual space can be referenced in terms of x, y coordinates for a virtual plane and in terms of x, y, z coordinates for a virtual space.

Objects, targets, beacons or navigation destinations, in the space should naturally follow the expansion and contraction of space.

All previously described features can also be incorporated into this aspect of the invention.

According to another aspect of the invention there is provided a method for human-computer interaction on a graphical user interface (GUI), the method including the steps of:
determining coordinates of a pointer with, or relative, to an input device;
determining interaction coordinates of interactive objects;
determining display coordinates of interactive objects of which at least two objects are displayed;
establishing a threshold in relation to the interactive objects and in relation to space about them;
prioritising the interactive objects in relation to their distance and/or direction to the pointer;
moving the interactive objects and thresholds relative to the object priority;
repeating the above steps every time the coordinates of the pointer changes; and
performing an action when a threshold is reached.

All previously described features can also be incorporated into this aspect of the invention.

According to another aspect of the invention, there is provided a navigation tool, which tool is configured to:
determine coordinates of a pointer with, or relative, to an input device;
determine coordinates of interactive objects of which at least two objects are displayed;
establish a threshold in relation to the interactive objects and in relation to space about them;
prioritise the interactive objects in relation to their distance and/or direction to the pointer;
move the interactive objects and thresholds relative to the object priority;
repeat the above steps every time the coordinates of the pointer changes; and perform an action when a threshold is reached.

All previously described features can also be incorporated into this aspect of the invention.

According to another aspect of the invention, there is provided a graphic user interface, which is configured to:

determine coordinates of a pointer with, or relative, to an input device;
determine coordinates of interactive objects of which at least two objects are displayed;
establish a threshold in relation to the interactive objects and in relation to space about them;
prioritise the interactive objects in relation to their distance and/or direction to the pointer;
move the interactive objects and thresholds relative to the object priority;
repeat the above steps every time the coordinates of the pointer changes; and perform an action when a threshold is reached.

According to another aspect of the invention, there is provided a computer and a computer operated device, which includes a GUI or a navigation tool as described above.

### DEFINITIONS

1. Pointer—Is a point in a virtual plane or space at which a user is navigating at a point in time, and may be invisible or may be graphically represented and displayed on the GUI such as an arrow, hand and the like which can be moved to select an interactive object displayed on the GUI. This is also the position at which a user can make an input.

2. Interactive objects—Includes objects such as icons, menu bars, and the like, displayed on the GUI, visible and non visible, which is interactive and enters a command into a computer, when selected, for example. Interactive objects include cooperative targets of a user.

3. Non-visible interactive object—The interactive space between interactive objects or an interactive point in the space between interactive objects or a hidden interactive object.

4. Pointer object is an object used by a person to manipulate the pointer and is an object above a pointing device or above a touch sensitive input device, typically a stylus or the finger or other part of a person, but in other circumstances also eye movement or the like.

5. Virtual z coordinate value is the z coordinate value assigned to an interactive object visible and non-visible.

### DETAILED DESCRIPTION OF THE INVENTION

The invention is now described by way of example with reference to the accompanying drawings.

In the drawings:

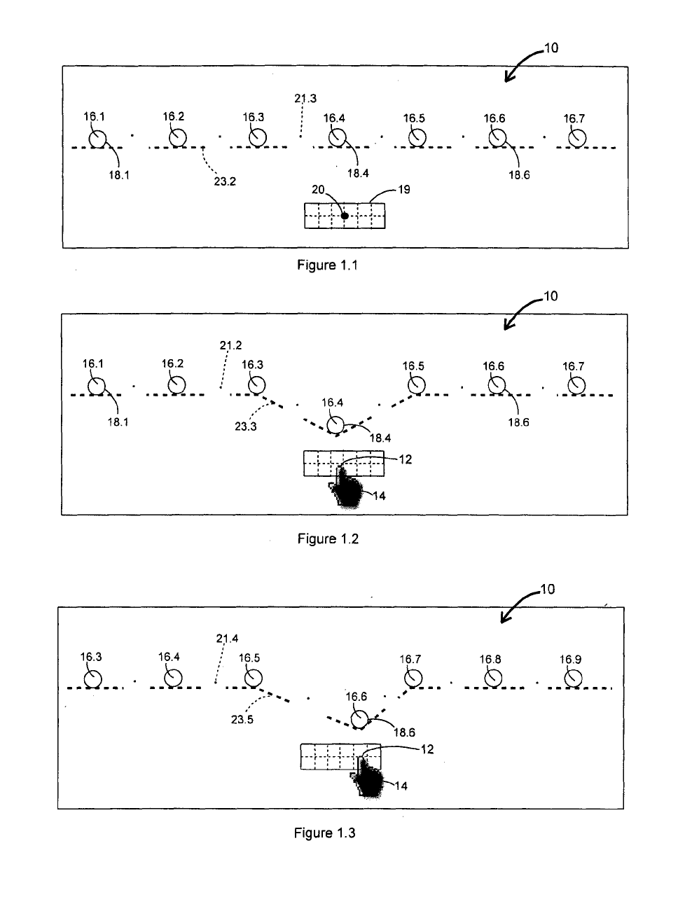

FIG. 1 shows schematically an example of a series of human-computer interactions on a GUI, in accordance with the invention;

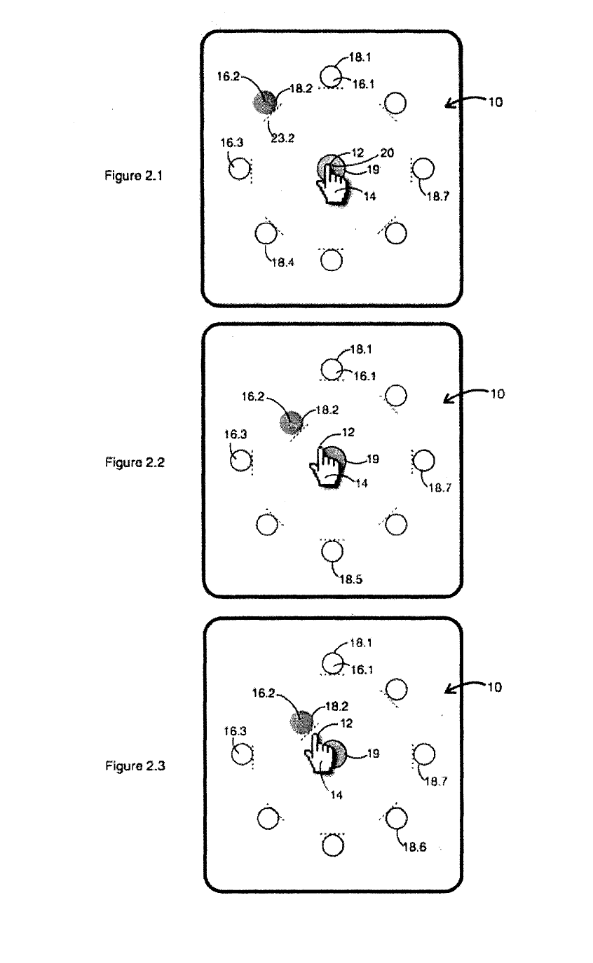

FIG. 2 shows schematically a further example of a series of human-computer interactions on a GUI, in accordance with the invention;

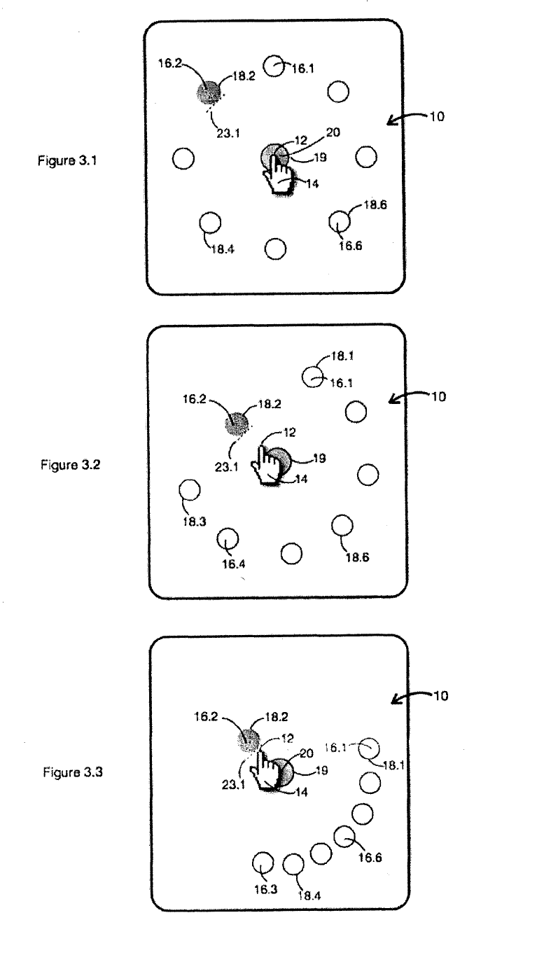

FIG. 3 shows schematically a further example of a series of human-computer interactions on a GUI, in accordance with the invention;

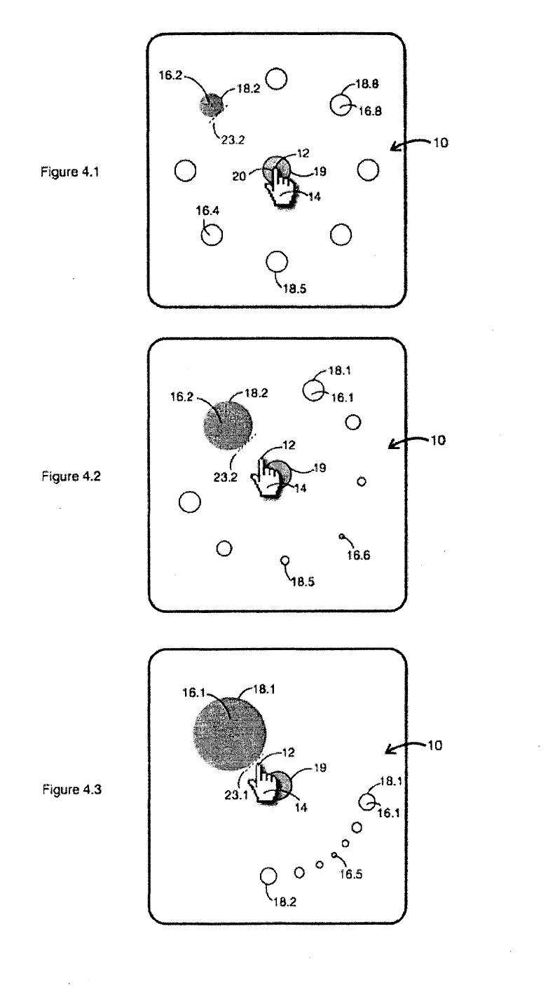

FIG. 4 shows schematically a further example of a series of human-computer interactions on a GUI, in accordance with the invention;

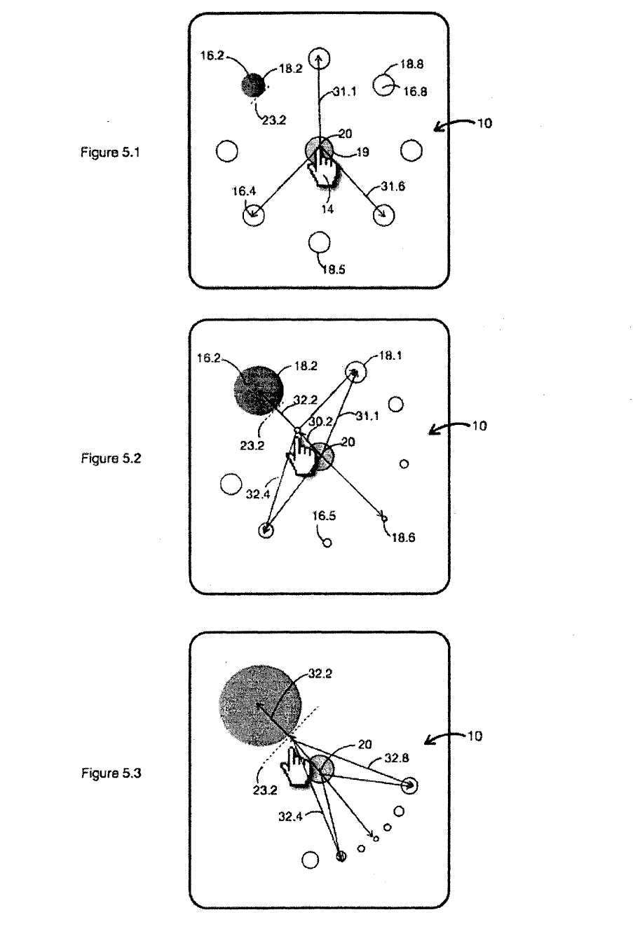

FIG. 5 shows schematically a further example of a series of human-computer interactions on a GUI, in accordance with the invention;

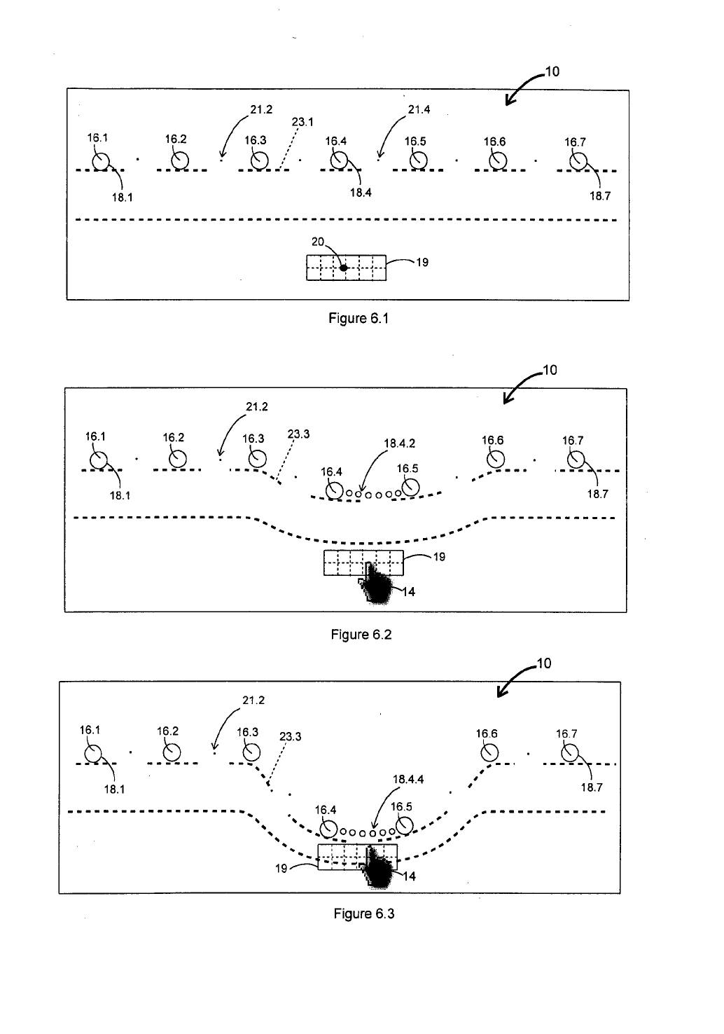

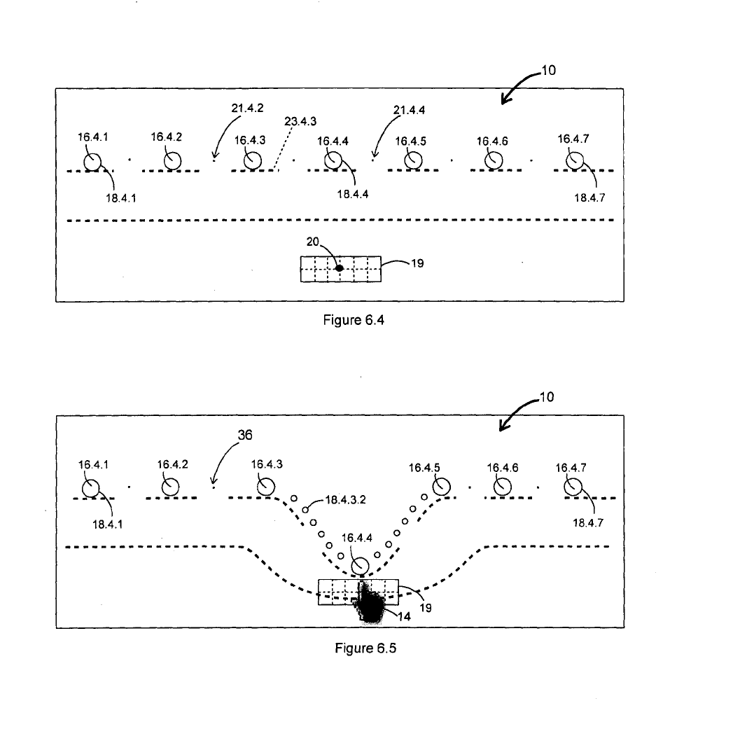

FIG. 6 shows schematically a further example of a series of human-computer interactions on a GUI, in accordance with the invention;

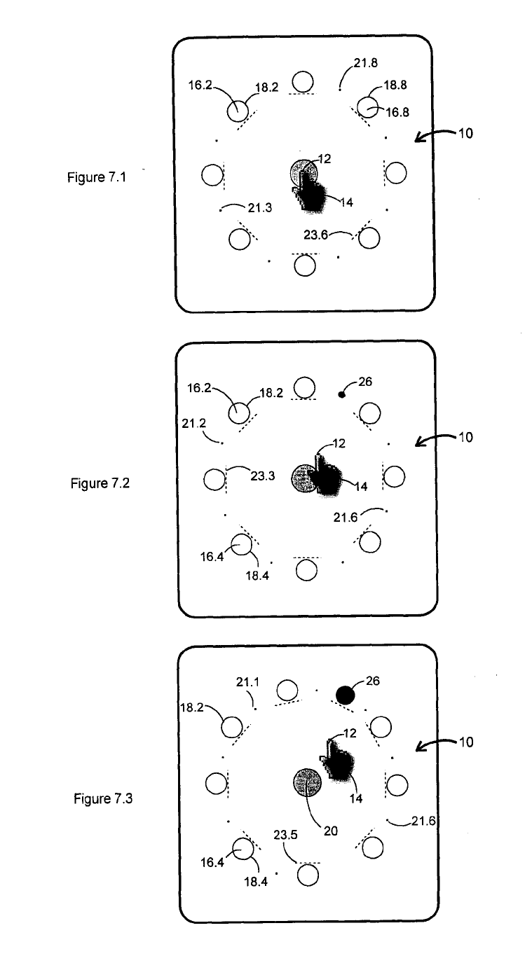

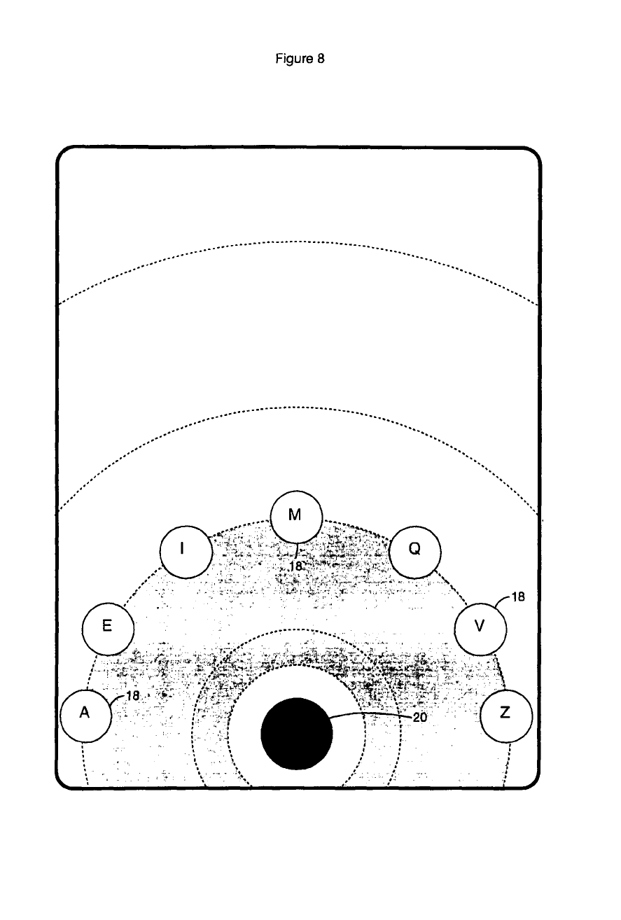

FIG. 7 shows schematically a further example of a series of human-computer interactions on a GUI, in accordance with the invention;

FIG. 8 shows schematically an example of the arrangement of interactive objects about a central point;

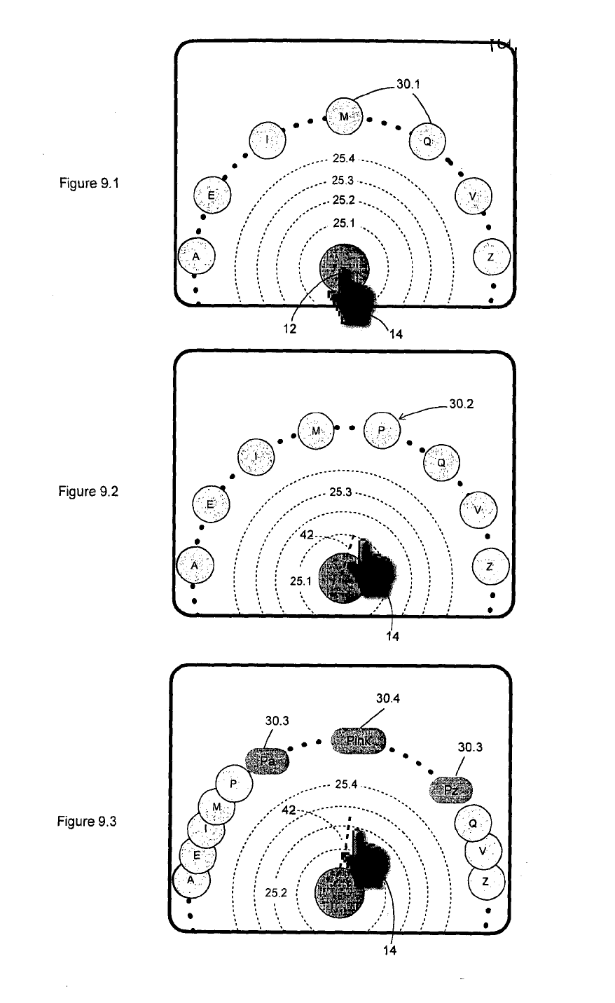

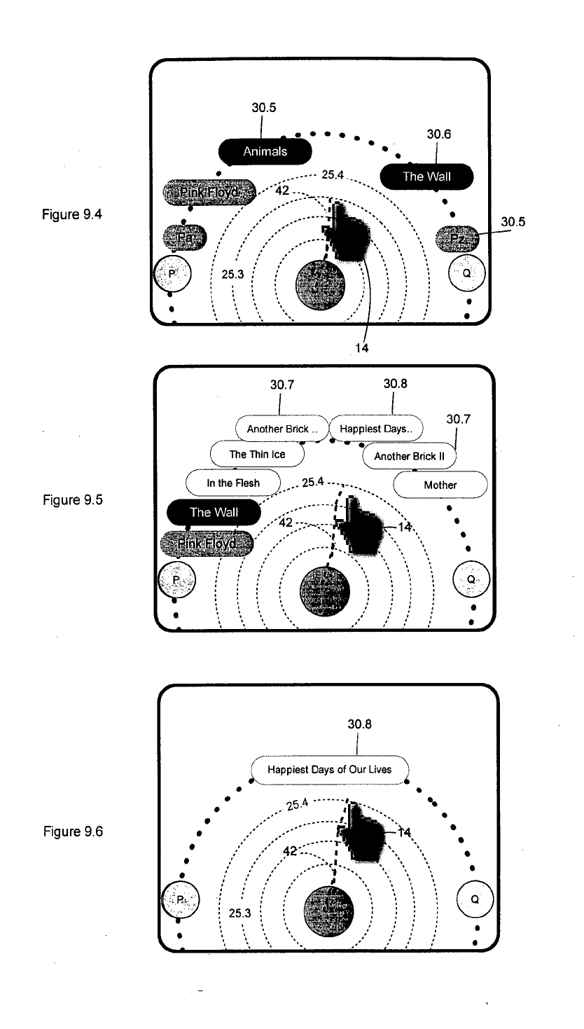

FIG. 9 demonstrates schematically a series of practical human-computer interactions to complete a number of interactions;

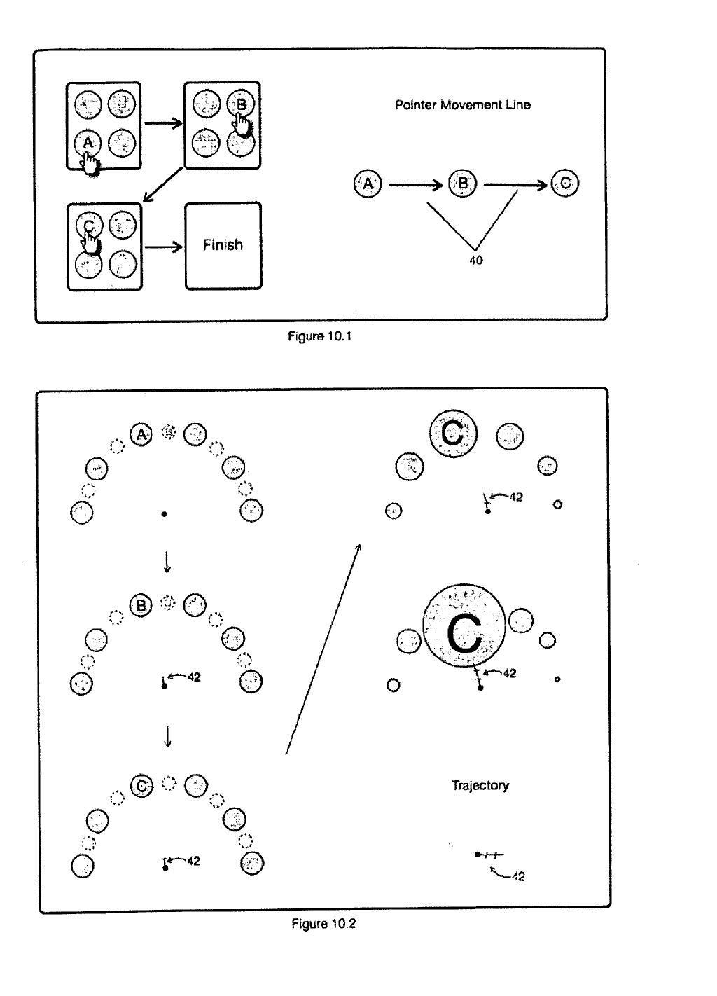

FIG. 10 demonstrates schematically the difference between a pointer movement line to complete an interaction on a computer on the known GUI and a mapping line on the GUI in accordance with the invention to complete the same interaction on the computer;

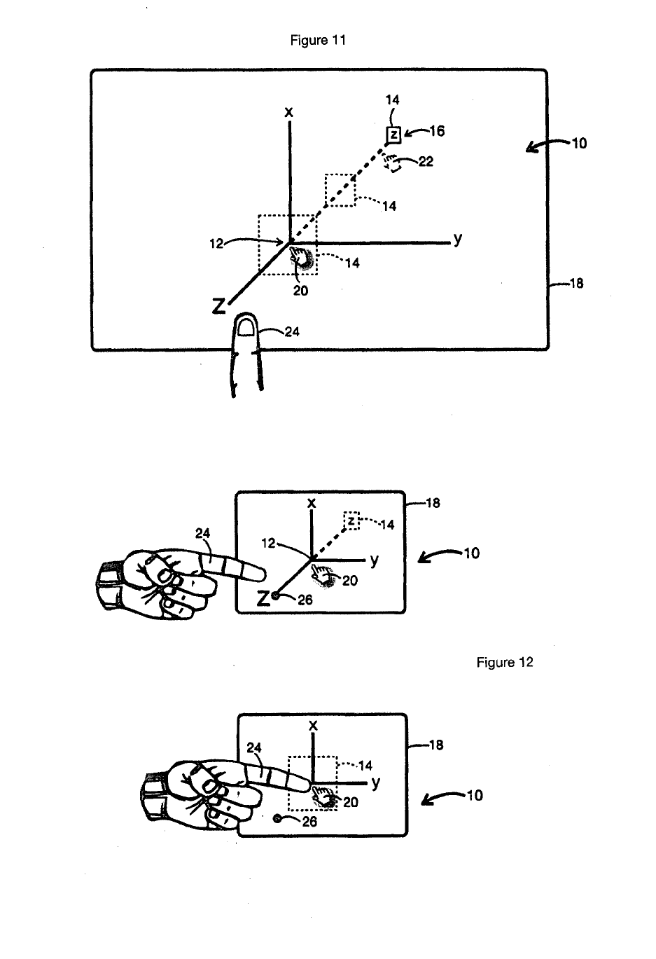

FIG. 11 shows schematically the incorporation of a z and Z-axis for human-computer interaction, in accordance with the invention;

FIG. 12 shows an example of the relationship between the z and Z-axis, in accordance with the invention;

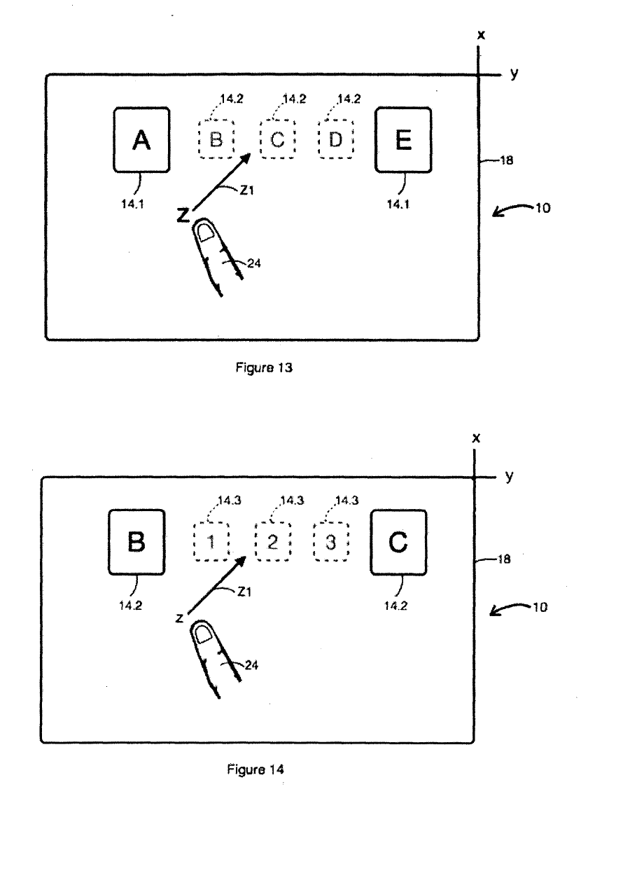

FIGS. 13 to 16 demonstrate schematically a series of practical human-computer interactions to complete a number of interactions, using a three-dimensional input device, in accordance with the invention;

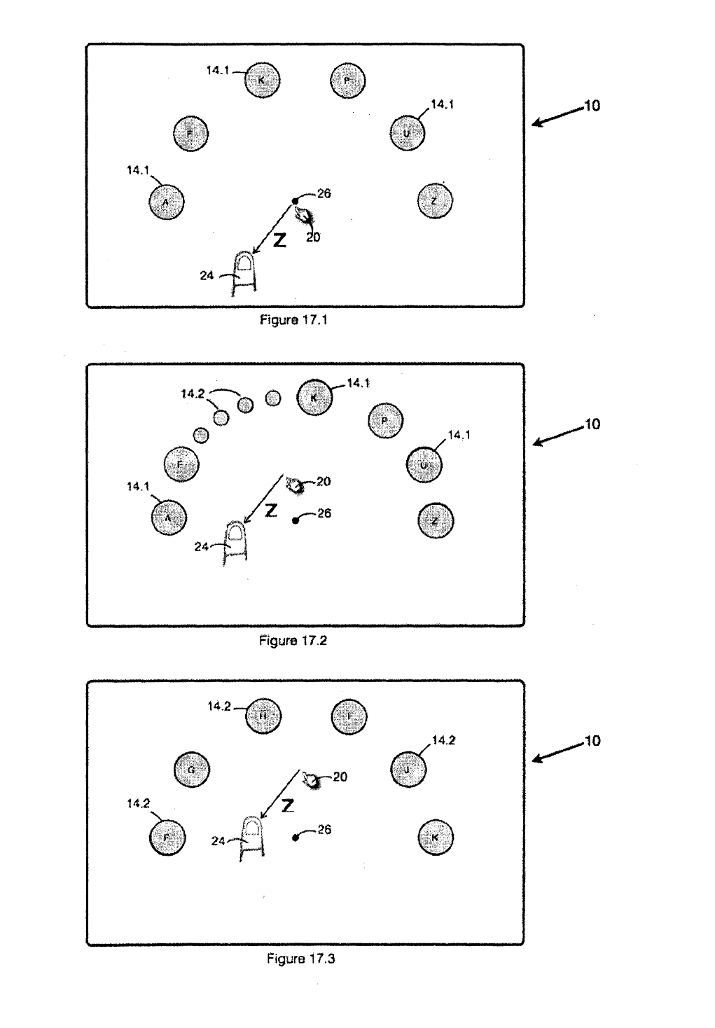

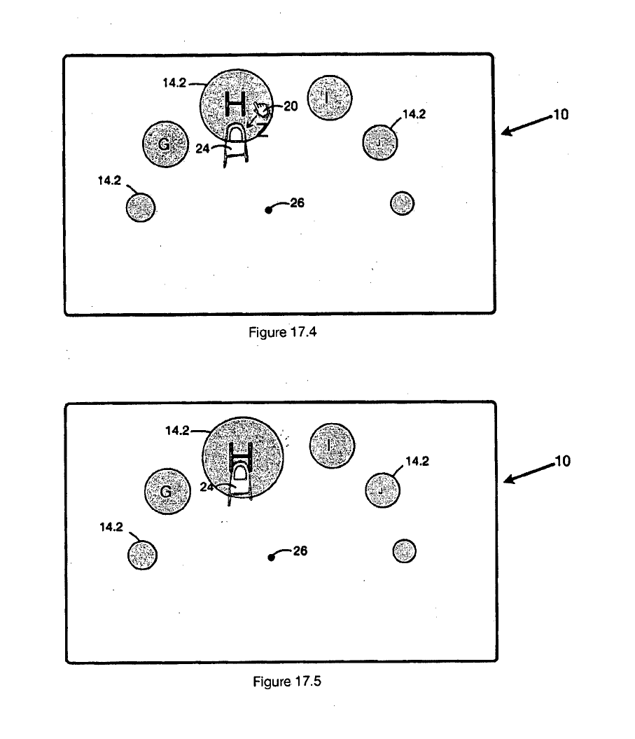

FIG. 17 demonstrates schematically a further example of practical human-computer interactions to complete a number of interactions, using a three-dimensional input device, in accordance with the invention;

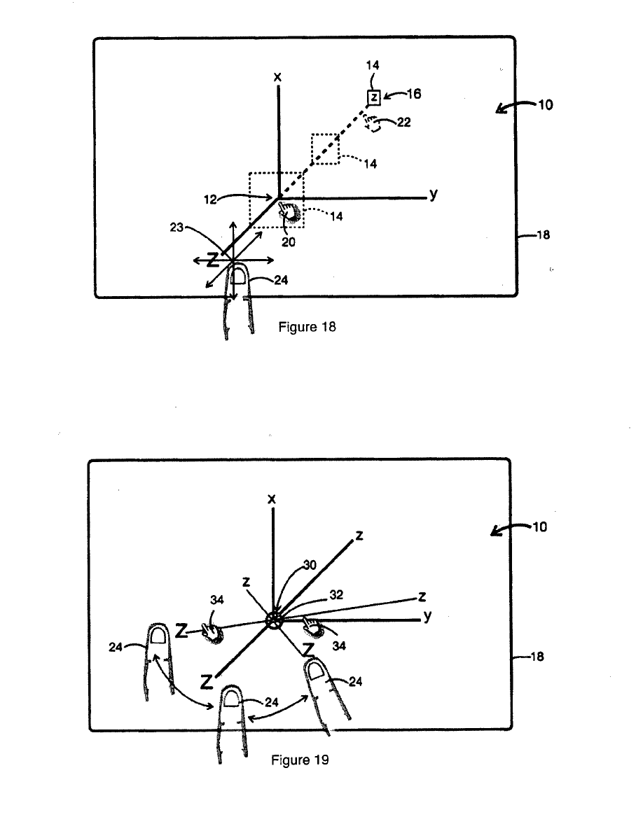

FIG. 18 shows schematically the use of the direction and movement of a pointer object in terms of its x, y and Z coordinates for human-computer interaction, in accordance with the invention;

FIG. 19 shows schematically the use of the characteristics of the Z-axis for human-computer interaction, in accordance with the invention;

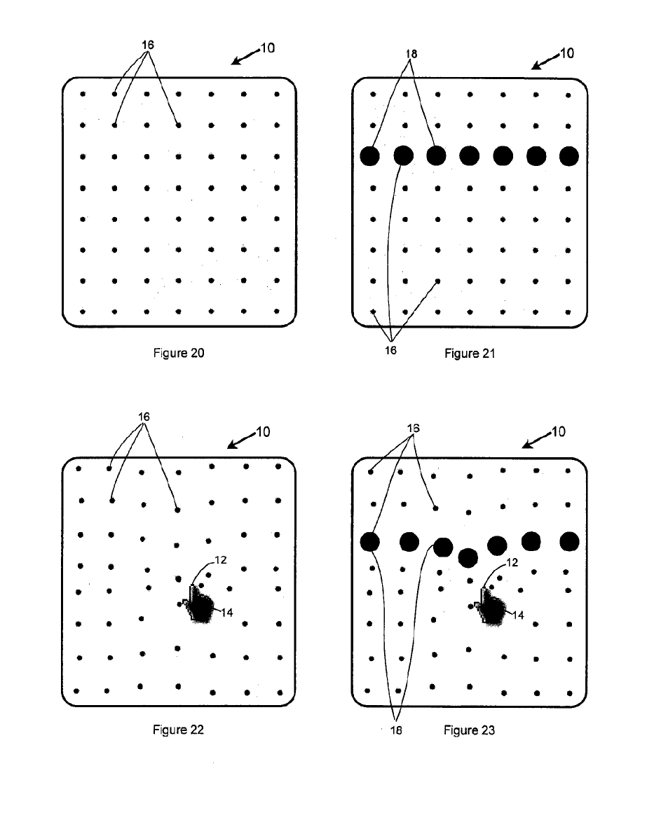

FIGS. 20 to 23 show schematically a further example of a series of human-computer interactions on a GUI, in accordance with the invention;

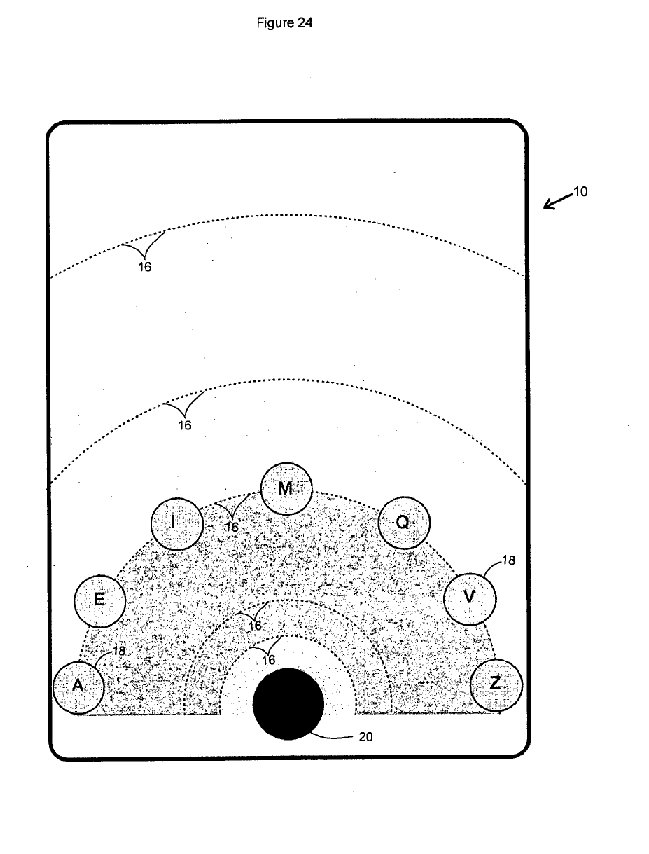

FIG. 24, shows schematically an example where points in a space are referenced in a circular pattern around a centre referenced point, in accordance with the invention;

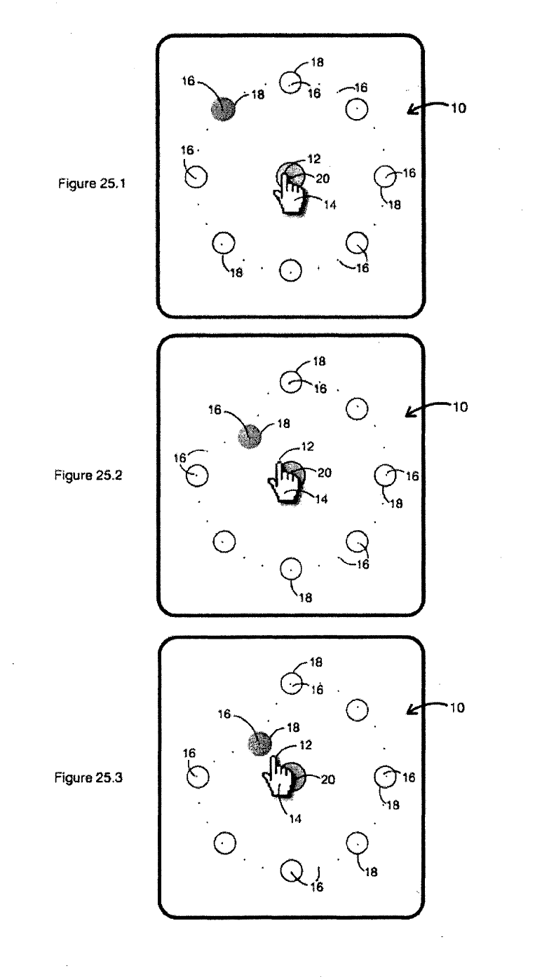

FIG. 25 shows schematically a further example of a series of human-computer interactions on a GUI, in accordance with the invention;

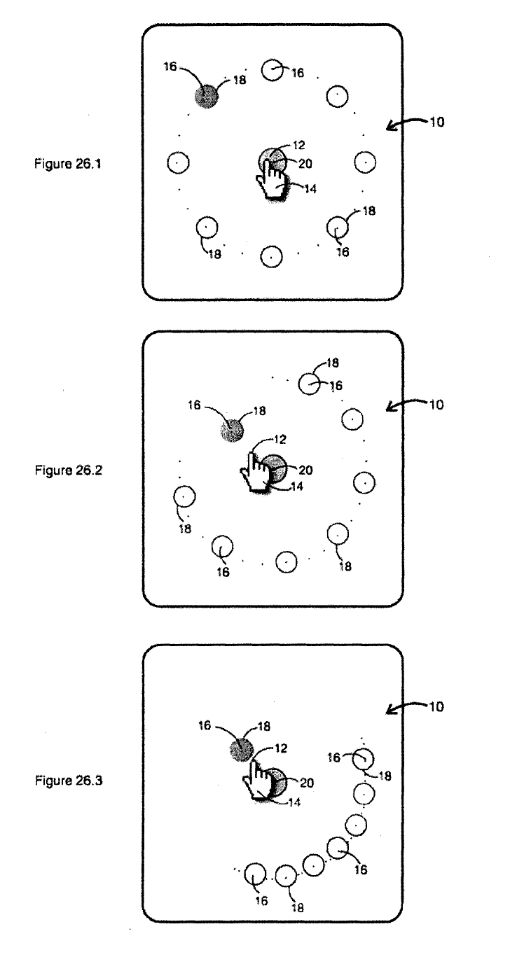

FIG. 26 shows schematically a further example of a series of human-computer interactions on a GUI, in accordance with the invention;

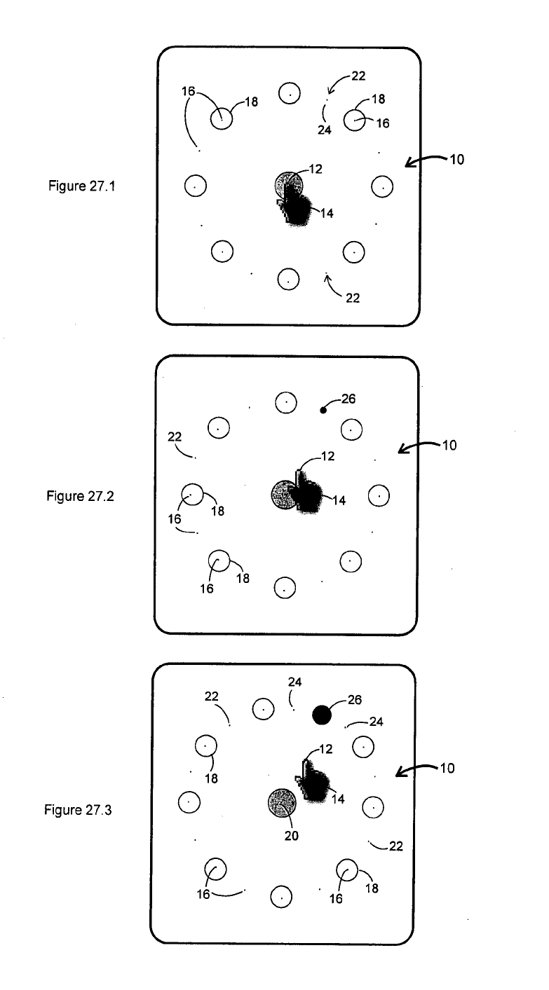

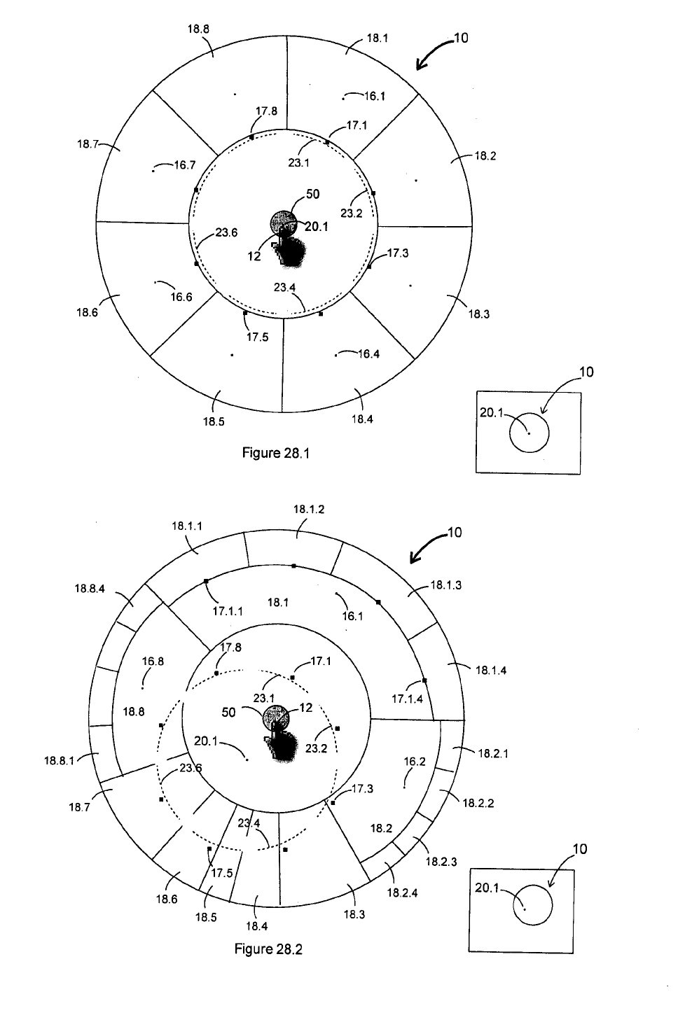

FIG. 27 shows schematically a further example of a series of human-computer interactions on a GUI, in accordance with the invention;

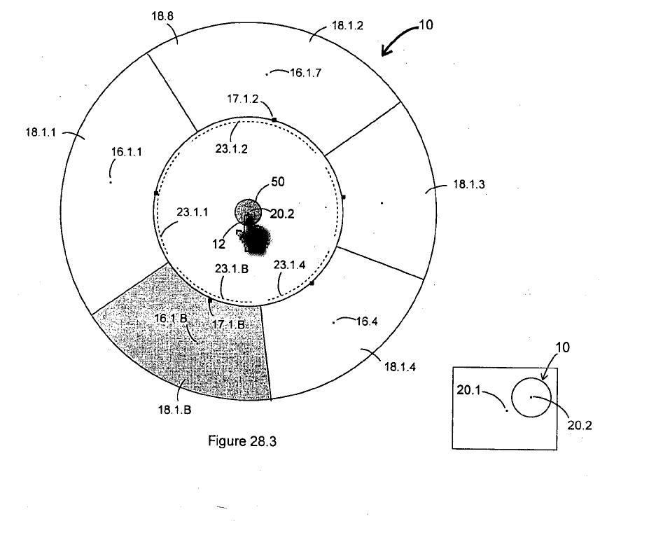

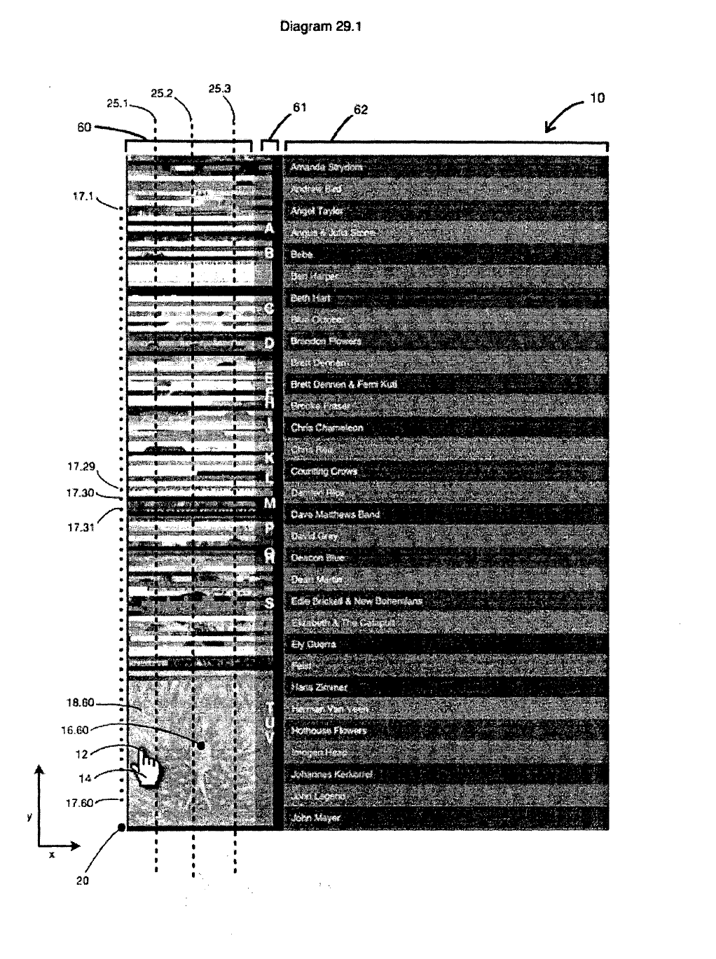

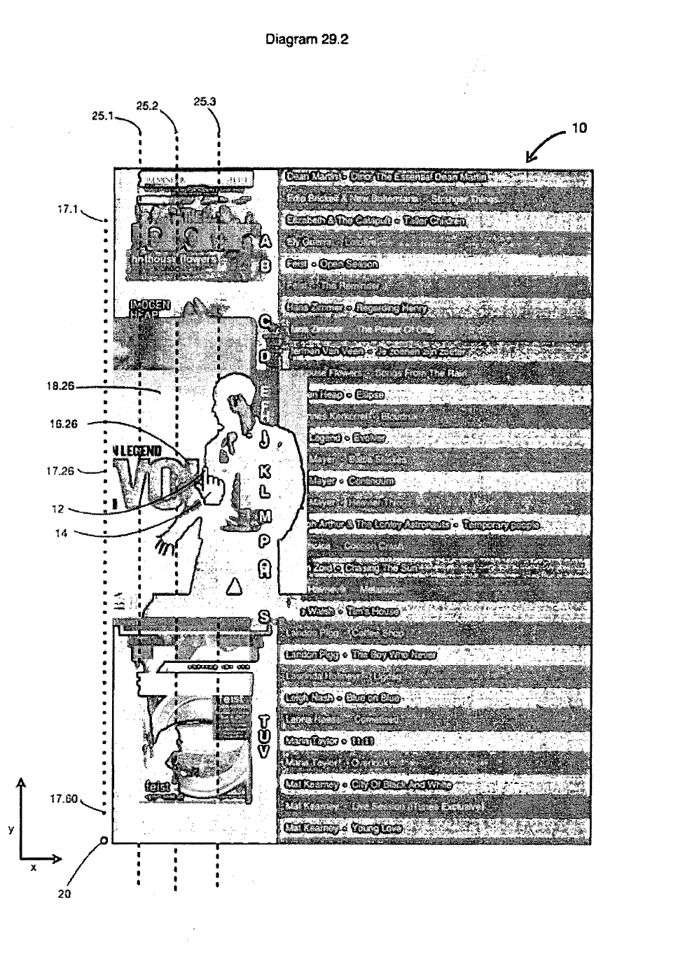

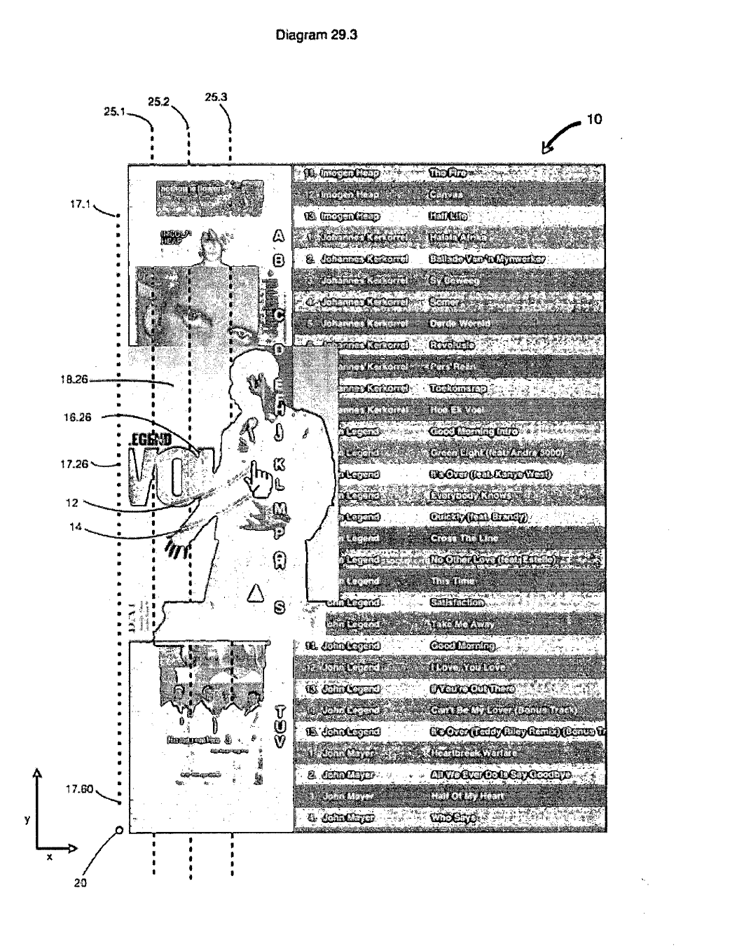

FIG. 28 shows an example of a method for recursively navigating hierarchical data, in accordance with the invention;

FIG. 29 demonstrates schematically a further example of practical human-computer interactions to complete a number of interactions, in accordance with the invention.

FIG. 30 shows an example of a geometry which can be used to use distance and angular measurements for respective inputs with regard to interactive objects;

FIG. 31 shows an example of a geometry which can be used to use distance and angular measurements from the pointer for respective inputs with regard to interactive objects;

FIG. 32 shows examples of convex shapes;

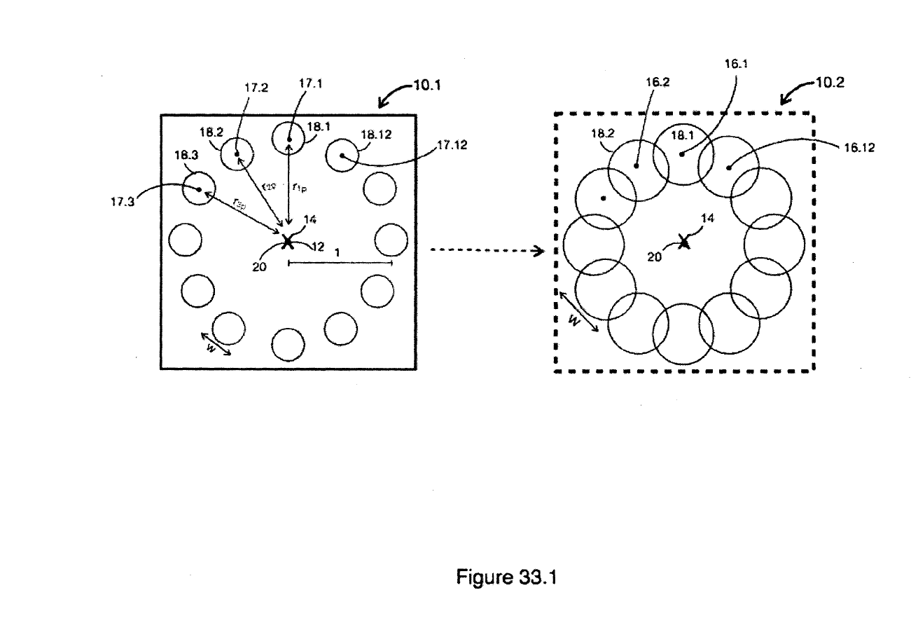

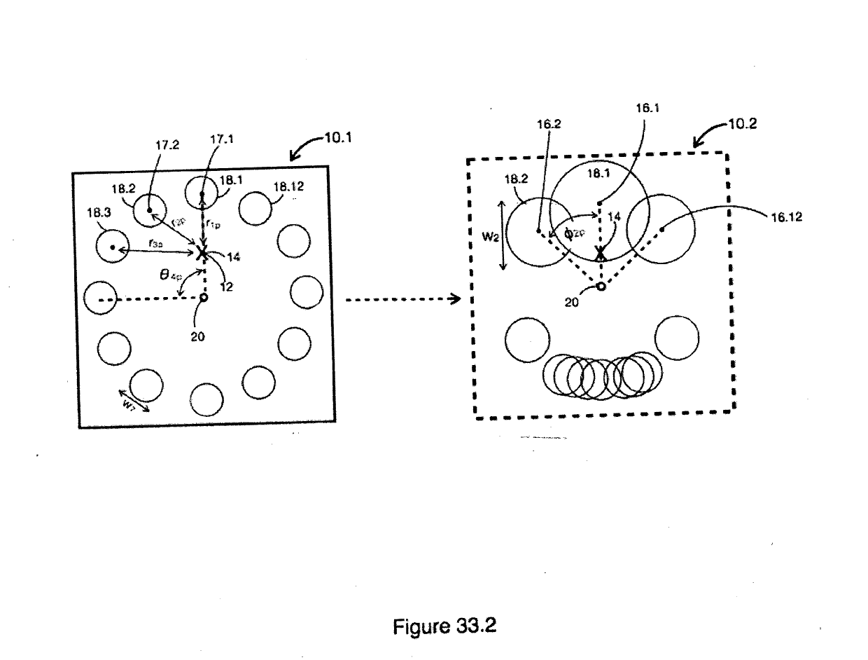

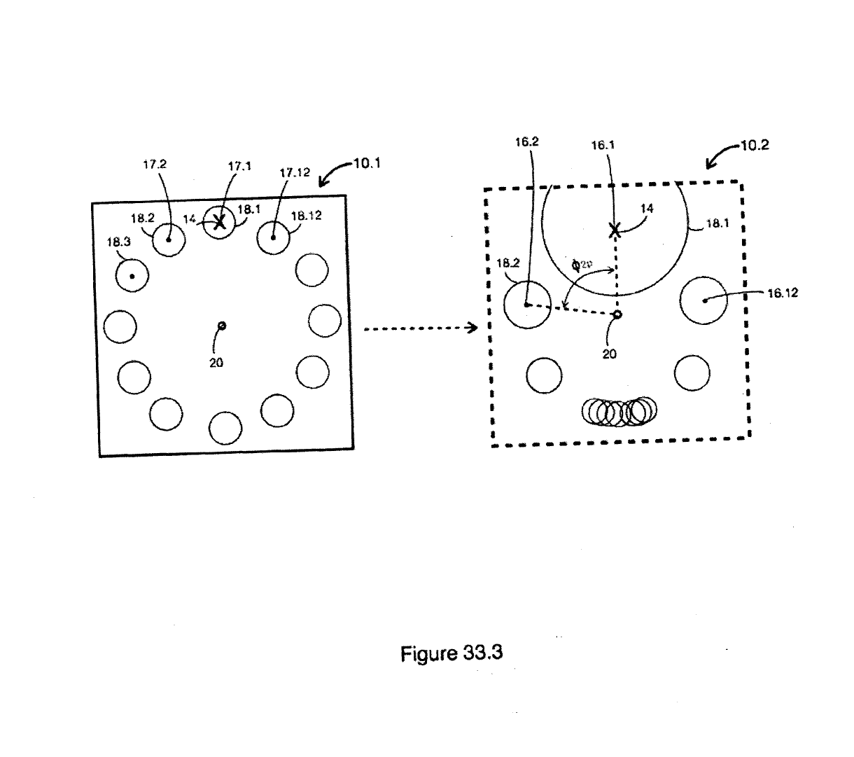

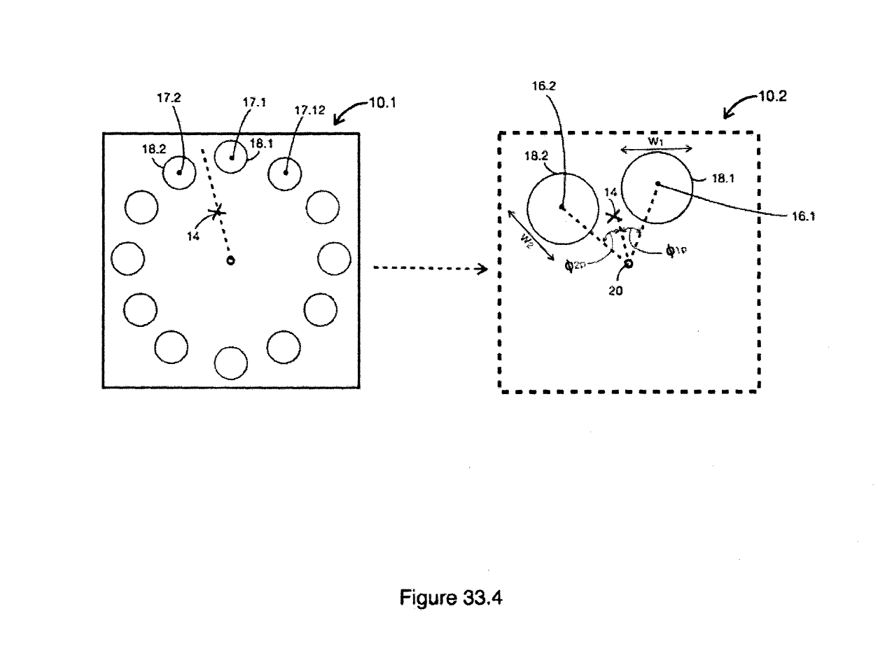

FIG. 33 shows an example of using separate interaction and display coordinates to provide a specific interaction behaviour and visual advantage to the user, in accordance with the invention;

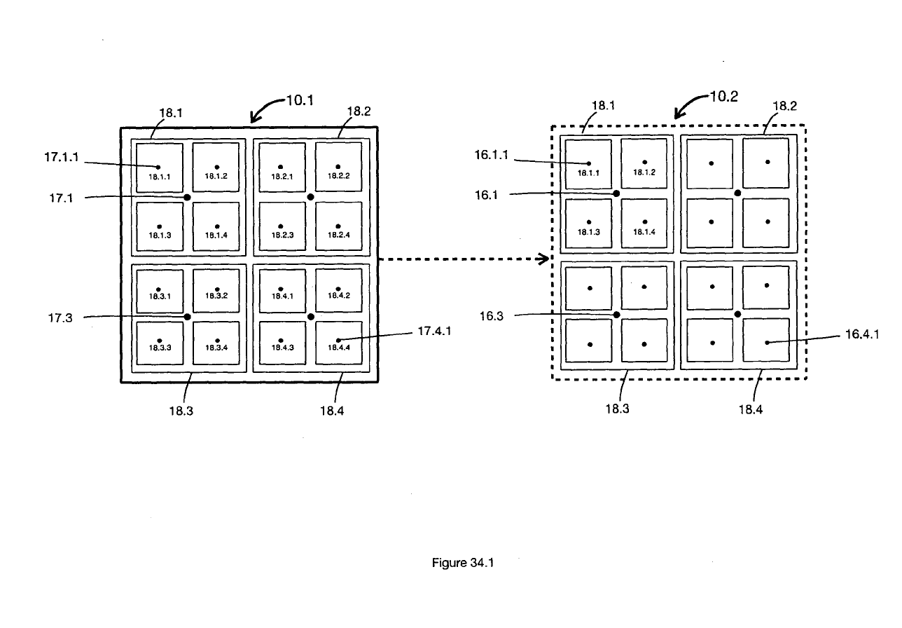

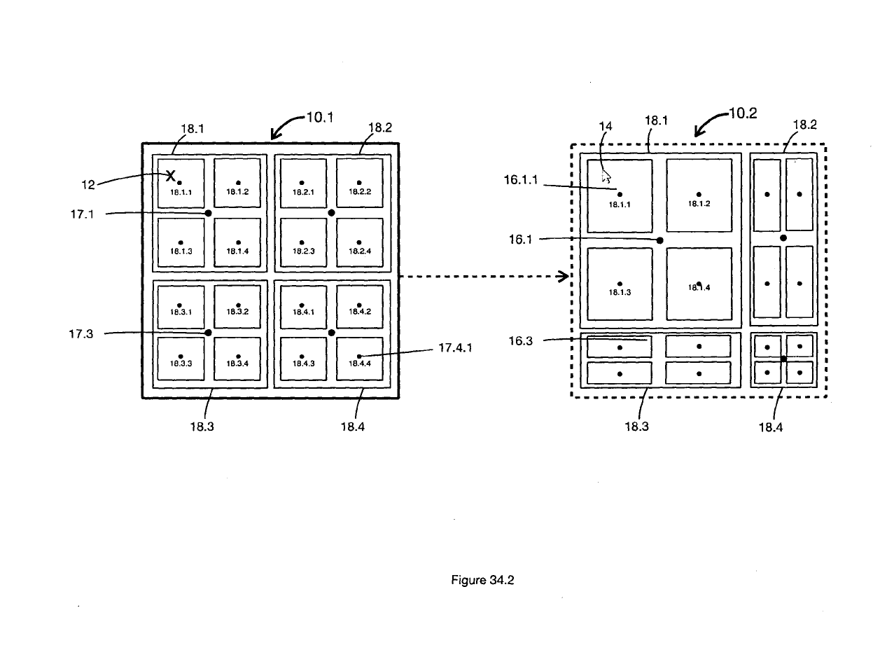

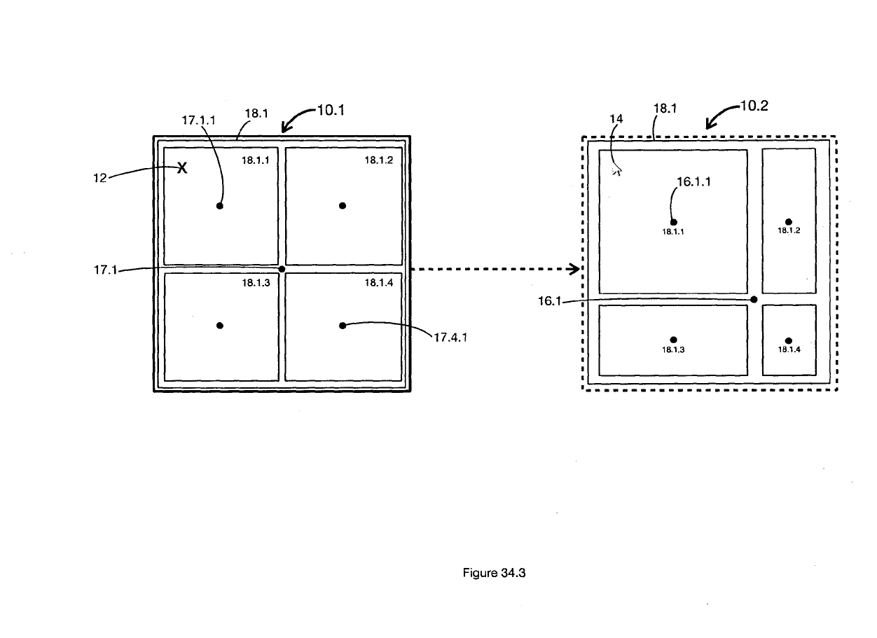

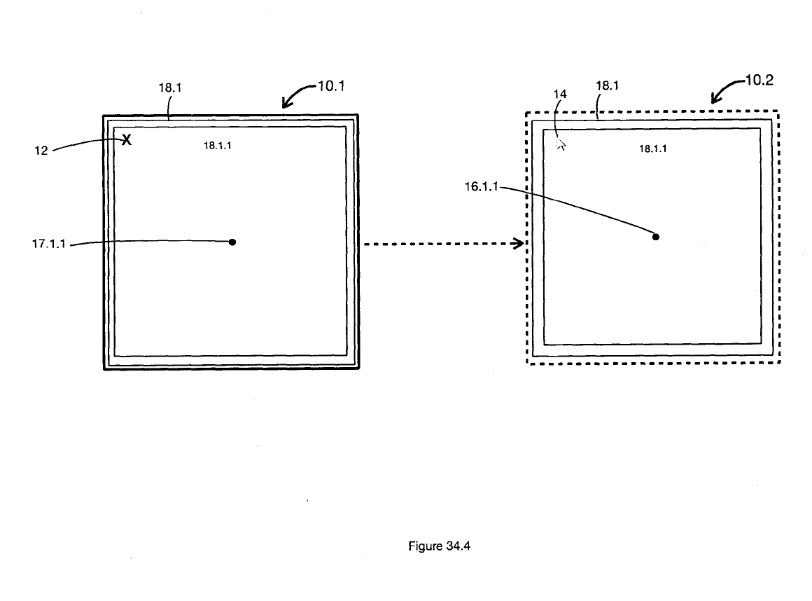

FIG. 34 shows an example of using separate interaction and display coordinates, along with a three-dimensional input device, to recursively navigate a hierarchical data set;

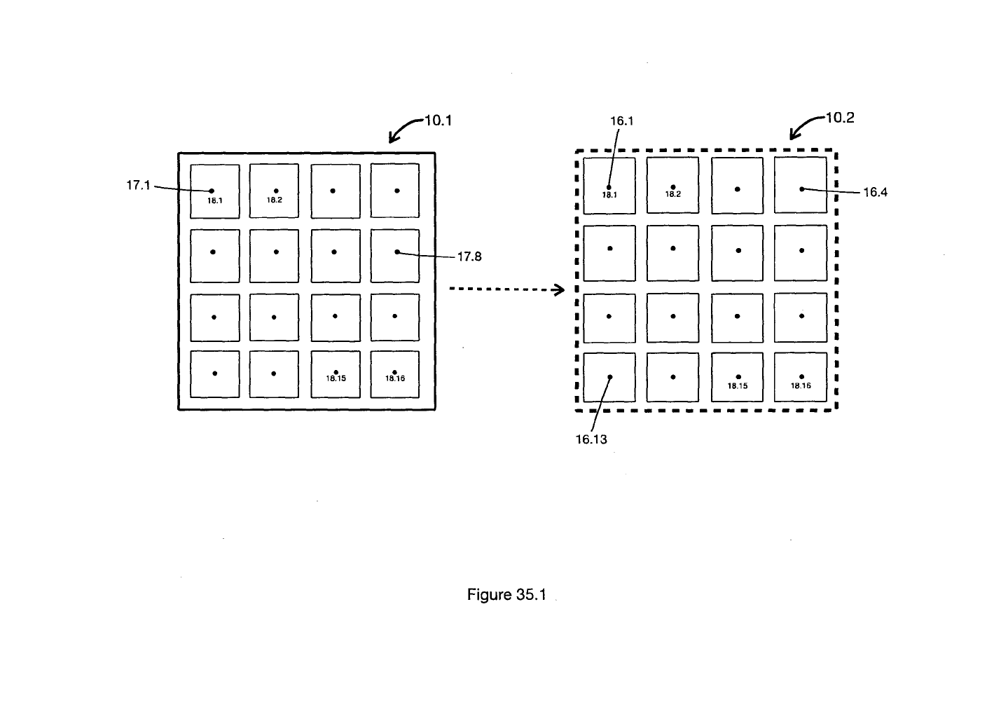

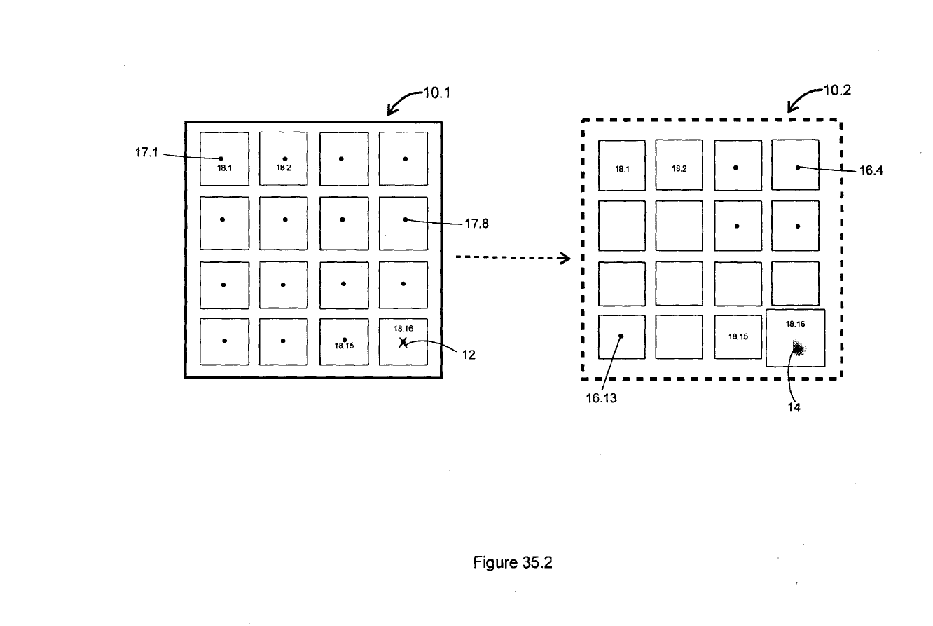

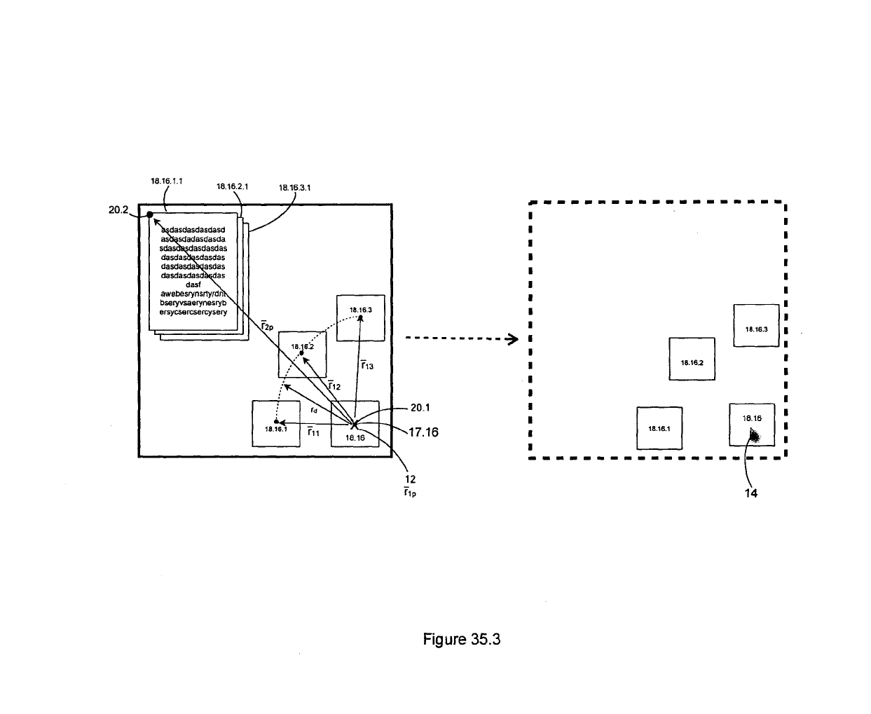

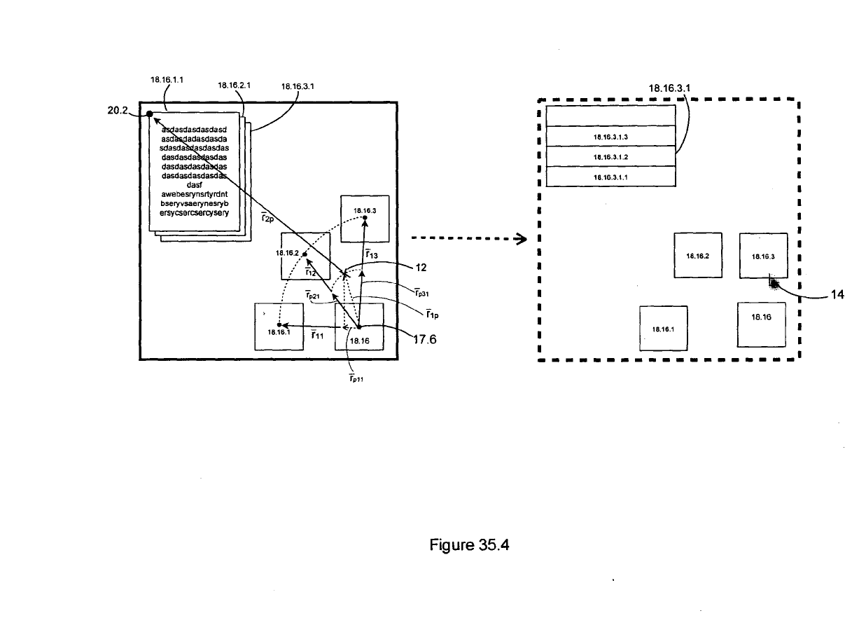

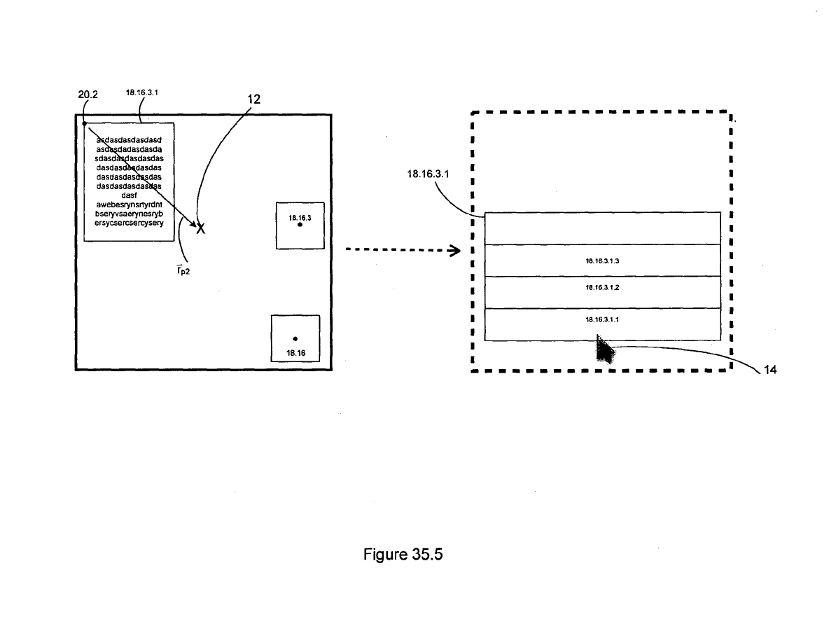

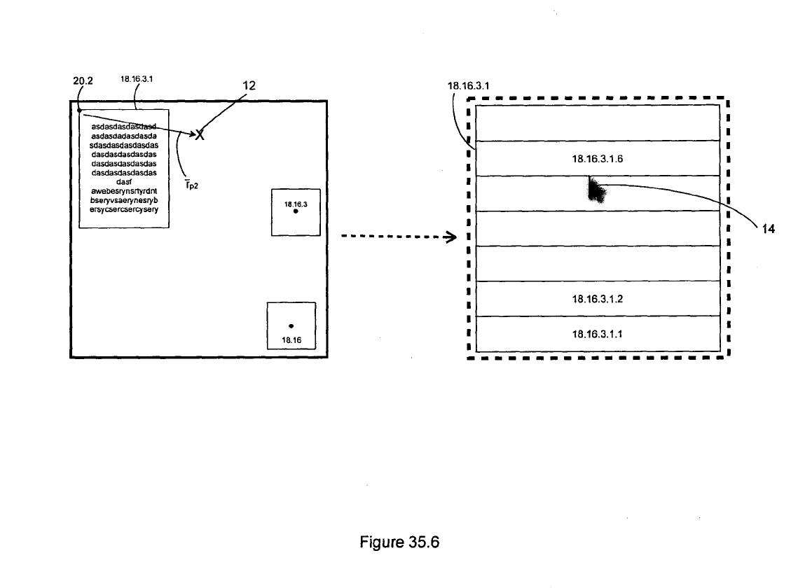

FIG. 35 shows an example of using separate interaction and display coordinates to perform a series of navigation and selection steps, in accordance with the invention;

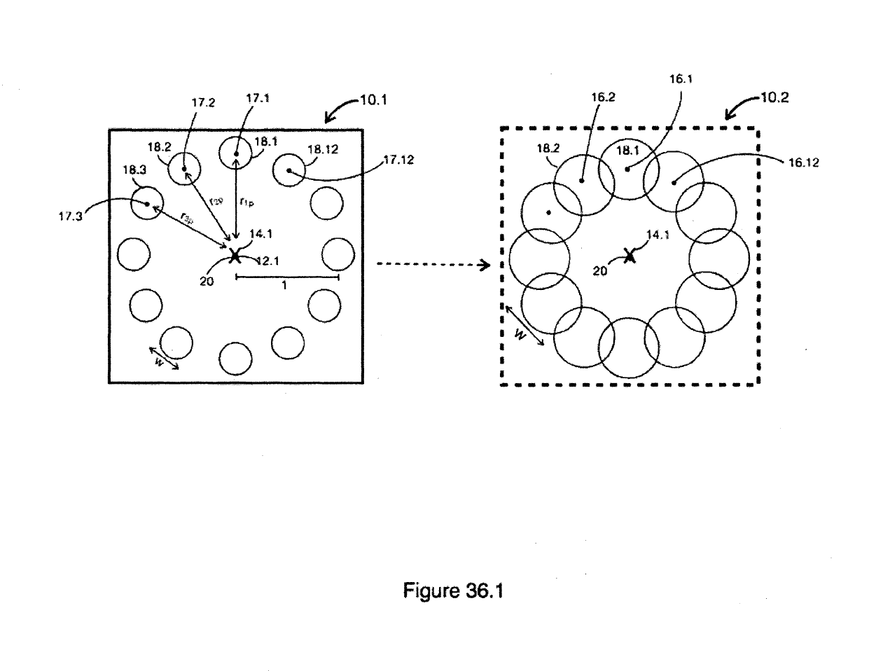

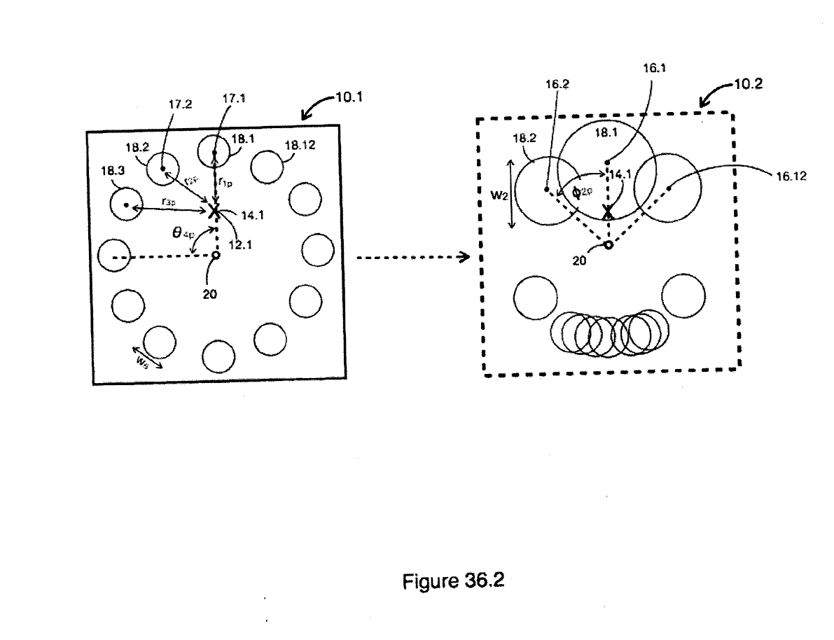

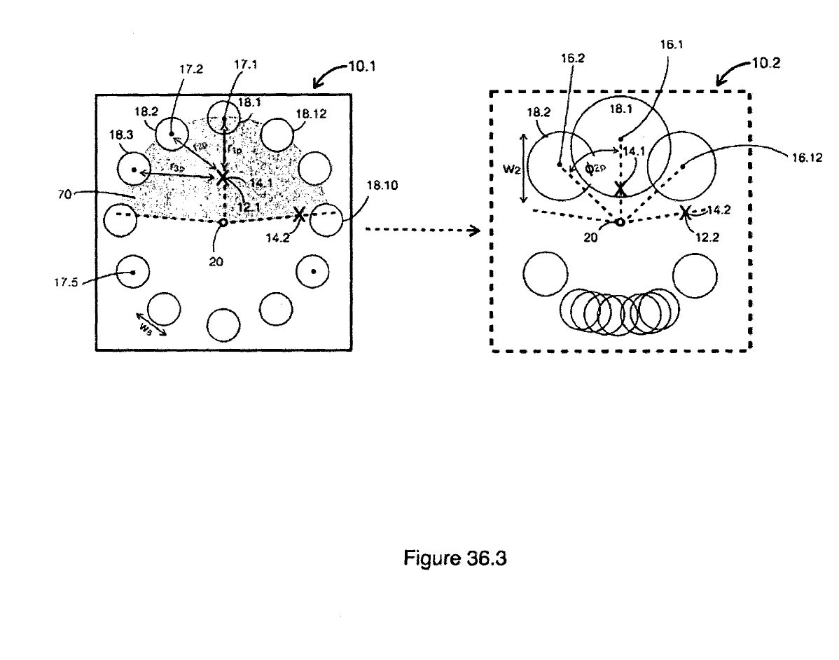

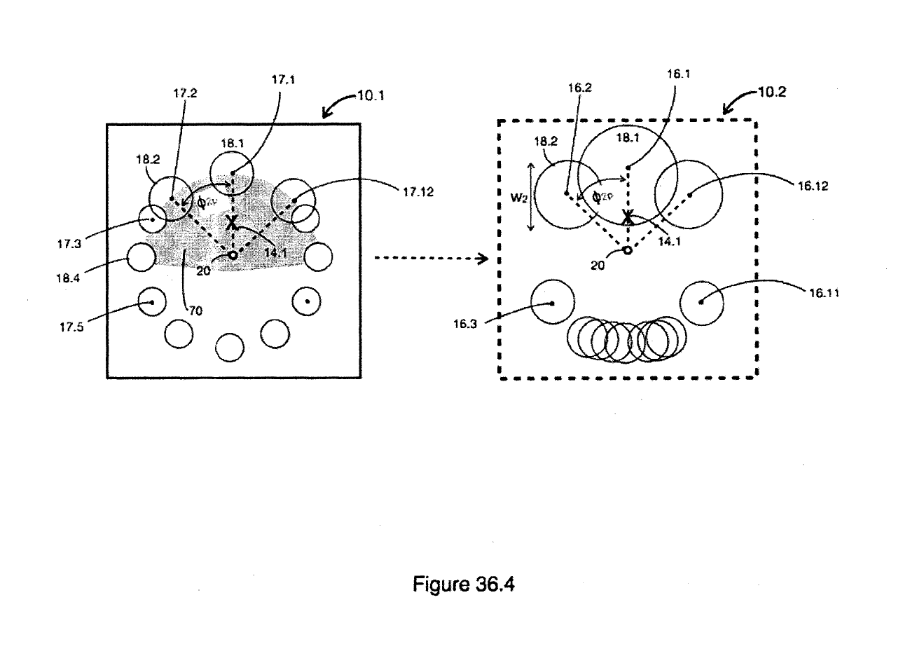

FIG. 36 shows an example of using separate interaction and display coordinates, along with a second pointer, to provide different interaction behaviours; and

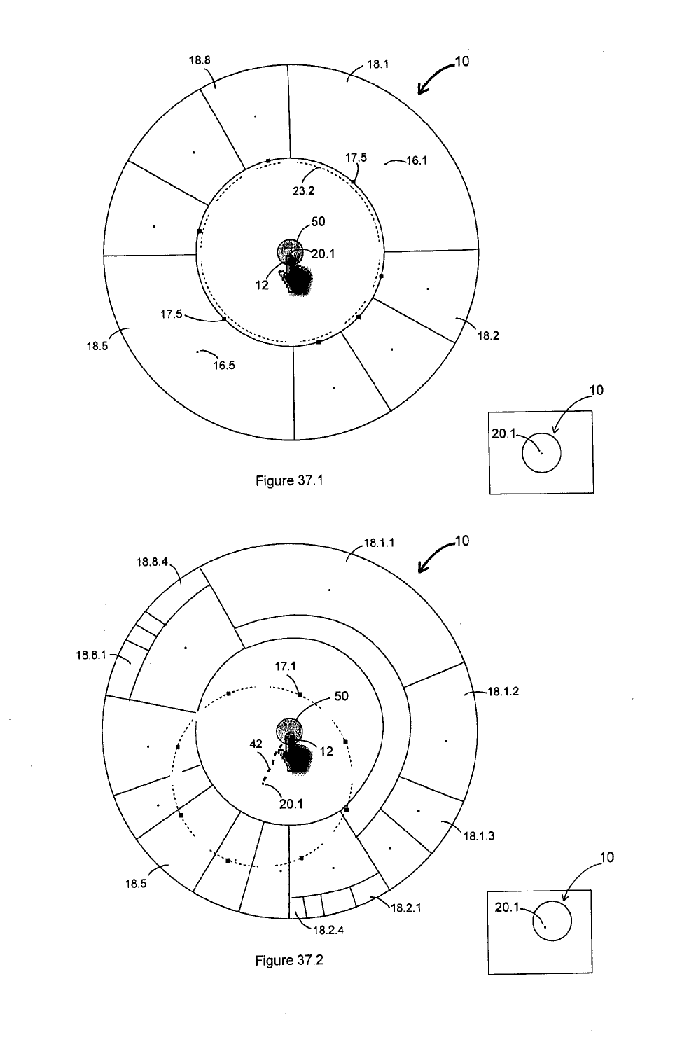

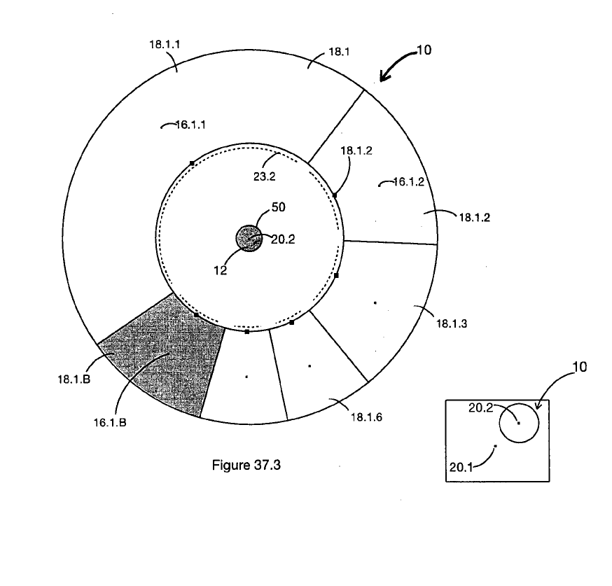

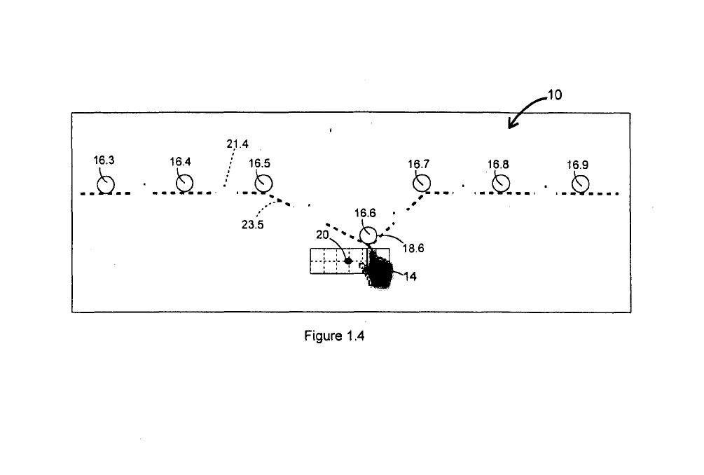

FIG. 37 shows an example of a method for recursively navigating hierarchical data with un-equal relative importance associated with objects in the data set.

In the exemplary diagrams and the descriptions below, a set of items may be denoted by the same numeral, while a specific item is denoted by sub-numerals. For example, 18 or 18.i denote the set of interactive objects, while 18.1 and 18.2 respectively denotes the first and second object. In a case of a hierarchy of items, further sub-numerals, for example 18.i.j and 18.i.j.k, will be employed.

Referring now to FIG. 1, the GUI, in accordance with the invention, is generally indicated by reference numeral 10. A representation 14 of a pointer may be displayed on the GUI 10 when the input device is not also the display. A method, in accordance with the invention, for human-computer interaction on a GUI 10 includes the steps of determining coordinates 12 of a pointer 14 with, or relative to, an input device, as well as determining the coordinates 16 of interactive objects 18 displayed on the GUI relative to the coordinates 12 of the pointer 14. The method further includes the steps of establishing a set of thresholds 23 in relation to the interactive objects 18 and a set of thresholds 21 in relation to the space about interactive objects 18. The method includes the steps of prioritising the interactive objects 18 in relation to their distance to the pointer 14 and moving the interactive objects 18 and thresholds 21 and 23 relative to the object priorities. These steps are repeated every time the coordinates 12 of the pointer 14 change. The method further includes the step of performing an action when a threshold 21 or 23 is reached. Where necessary, some interactive objects are scrolled off-screen while others are scrolled on-screen. The priority of an interactive object is a discrete value between 0 and 6 in this example, ordered to form a ranking, where 0 indicates the lowest and 6 the highest priority. Alternatively, the priority of an interactive object may be a continuous value between 0 and 1, where 0 indicates the lowest and 1 the highest priority. The highest priority will be given to the interactive object 18 closest to the pointer 14 coordinates 12 and the lowest priority to the furthest. When the new coordinates 16 of the interactive objects 18 are calculated the highest priority interactive object 18 is moved closer to the pointer coordinates 12 and so forth. A first set of thresholds 21, which coincides with space about the interactive objects, is established and a second set of threshold 23, which coincides with the perimeters of the interactive objects, is established. A function to access objects belonging logically in or behind space between displayed interactive objects is assigned to the first set of thresholds 21, and the function may be performed when a threshold 21 is activated when reached. A further function is assigned to the second set of thresholds 23 whereby an interactive object, 18.6 in this case, can be selected when a threshold 23 is pierced when the perimeter of the object is reached, for example by crossing the perimeter. The method may further include the step of updating the visual representation of pointer 14 when a threshold is reached. For example, the pointer's visual representation may change from an arrow icon to a selection icon when a threshold 23 is reached. An area 19 is allocated wherein the pointer 14's coordinates are representative. The method may further include the step of first fixing or determining a reference point 20 for the pointer, in this case the centre point of area 19, The pointer reference point 20 may be reset or repositioned as a new starting point for further navigation on the GUI, for example when the edge of the representative area 19 is reached, or when a threshold 23 is pierced or when threshold 21 is activated. In other embodiments, the reference point may also be reset or repositioned by a user such as when a pointer object is lifted from a touch sensitive input device. In FIG. 1.1 the objects are shown in their initial positions and no pointer is present. In FIG. 1.2 a pointer 14 is introduced in 19, with the effect that object 16.4 and its associated thresholds move closer to the pointer 14. In FIG. 1.3 the pointer 14 moved to the right. In reaction, all objects scrolled to the left so that objects 16.1 and 16.2 moved off-screen, while objects 16.8 and 16.9 moved on-screen. Interactive object 16.6 now has the highest priority and is moved closer to the pointer. In FIG. 1.4, the pointer 14 moved upwards and towards object 16.6, with the effect that it moved even closer to the pointer 14.

Referring now to FIG. 2, the GUI, in accordance with the invention, is generally indicated by reference numeral 10. In this case, a representation 14 of a pointer is displayed on the GUI 10 since the input device is not also the display. A method, in accordance with the invention, for human-computer interaction on a GUI 10 includes the steps of determining coordinates 12 of a pointer 14, with, or relative to, an input device, as well as determining the coordinates 16 of interactive objects 18 displayed in on the GUI relative to the coordinates 12 of the pointer 14. In this case, the objects 18 are arranged in a circular manner, such that every direction from the pointer 14's coordinates 12 points at not more than one object's position coordinates 16. Each object 18 is pointed at from the pointer 14 by a range of unique angles. A sequence of interactions, starting in FIG. 2.1 and ending in FIG. 2.3, is shown where the pointer moves from the reference point 20 towards interactive item 18.2. A set of thresholds 23 in relation to the interactive objects 18, which coincides with the perimeters of the interactive objects 18, is established. The method further includes the steps of prioritising the interactive objects 18 in relation to their direction to the pointer 14 and moving the interactive object 18.2 (shown in grey) and its threshold 23.2 nearest to the pointer 14, having the highest priority, closer to the pointer coordinates 12 and repeating the above steps every time the coordinates 12 of the pointer 14 changes. The method further includes the step of performing an action when a threshold 23 is reached. The priority of an interactive object is a discrete value between 0 and 7 in this example, ordered to form a ranking, where 0 indicates the lowest and 7 the highest priority. Alternatively, the priority of an interactive object can be a continuous value between 0 and 1, where 0 indicates the lowest and 1 the highest priority. The highest priority will be given to the interactive object 18 closest to the pointer 14 coordinates 12 and the lowest priority to the furthest. When the new coordinates 16 of the interactive objects 18 are calculated, the highest priority interactive object 18.2 (shown in grey) and its threshold 23.2 will be moved closer to the pointer 14 and so forth. A function is assigned to the thresholds 23 whereby an interactive object, the grey 18.2 in this case, can be selected when the threshold 23.2 is pierced when the perimeter of the 18.2 is reached, for example by crossing the perimeter. The Highest priority object is selected when the coordinates 12 of pointer 14 and coordinates 16 of a prioritised interactive object 18 coincide. An area 19 is allocated wherein the pointer 14's coordinates 12 are representative. The method may further include the step of first fixing or determining a reference point 20 for the pointer, in this case the centre point of area 19. The pointer reference point 20 is reset, or alternatively repositioned, as a new starting point for further navigation on the GUI, for example when the edge of a display space is reached, or when the edge of the representative area 19 is reached, or when a threshold 23 is pierced, in the case where object 18 is a folder, for example. In other embodiments, the reference point may also be reset or repositioned by a user such as when a pointer object is lifted from a touch sensitive input device.

Referring now to FIG. 3, a method, in accordance with the invention, for human-computer interaction on a GUI 10 includes the steps of determining coordinates 12 of a pointer 14 with, or relative to, an input device, as well as determining the coordinates 16 of interactive objects 18 displayed on the GUI relative to the coordinates 12 of the pointer 14. In this case, the objects 18 are arranged in a circular manner, such that every direction from the pointer 14's coordinates 12 points at not more than one object 18's position coordinates 16. Each object 18 is pointed at from the pointer 14 by a unique range of angles. A sequence of interactions, starting in FIG. 3.1 and ending in FIG. 3.3, is shown where the pointer moves from the reference point 20 towards interactive item 18.2. A set of thresholds 23 in relation to the interactive objects 18, which coincides with the perimeters of the interactive objects, are established. The method further includes the steps of prioritising the interactive objects 18 in relation to their distance to the pointer 14's coordinates 12 and moving the interactive object 18.2 (shown in grey) and its threshold 23.2 nearest to the pointer 14 having the highest priority closer to the pointer 14 and repeating the above steps every time the coordinates 12 of the pointer 14 changes. The method further includes the step of performing an action when a threshold 23 is reached. The priority of an interactive object is a discrete value between 0 to 7 in this example, where 0 indicates the lowest and 7 the highest priority. Alternatively, the priority of an interactive object can be a continuous value between 0 and 1, where 0 indicates the lowest and 1 the highest priority. The highest priority will be given to the interactive object 18 closest to the pointer 14 and the lowest priority to the furthest. When the new coordinates 16 of the interactive objects are calculated the highest priority interactive grey object 18 will be moved closer to the pointer 14 and so forth. The method, in this example, includes the step of determining the coordinates 16 of the interactive objects 18 relative to each other. In this case the lower priority objects 18 are moved away from the higher priority objects and the pointer 14 according to each objects priority. The highest priority object 18.2 cooperates with the user, while other objects 18 act evasively. When the new coordinates 16 are calculated for the interactive objects 18 the highest priority interactive object will be moved closer to the pointer 14 and the lowest priority objects will be moved furthest away from the pointer and the other remaining objects in relation to their relative priorities. A function is assigned to the thresholds 23 whereby an interactive object, the grey 18 in this case, can be selected when a threshold 23 is pierced when the perimeter of the grey object 18 is reached, for example by crossing the perimeter. The Highest priority object 18.2 is selected when the coordinates 12 of pointer 14 and coordinates 16.2 of a prioritised interactive object 18.2 coincide. An area 19 is allocated wherein the pointer 14's coordinates are representative. The method may further include the step of first fixing or determining a reference point 20 for the pointer, in this case the centre point of area 19. The pointer reference point 20 is reset as a new starting point for further navigation on the GUI, for example when the edge of a display space is reached, or when the edge of the representative area 19 is reached, or when a threshold 23 is pierced, in the case where object 18 is a folder, for example. In another embodiment, the reference point may also be reset or repositioned by a user such as when a pointer object is lifted from a touch sensitive input device.

Referring now to FIG. 4, a method, in accordance with the invention, for human-computer interaction on a GUI 10 includes the steps of determining coordinates 12 of a pointer 14 with, or relative to, an input device, as well as determining the coordinates 16 of interactive objects 18 displayed on the GUI 10 relative to the coordinates 12 of the pointer 14. In this case, the objects 18 are arranged in a circular manner, such that every direction from the pointer 14's coordinates 12 may point at not more than one object 18's position coordinates 16. Each object 18 may be pointed at from the pointer 14 by a unique range of angles. A sequence of interactions, starting in FIG. 4.1 and ending in FIG. 4.3, is shown where the pointer moves from the reference point 20 towards interactive item 18.2. A set of thresholds 23, which coincides with the perimeter of the interactive objects, is established. The method further includes the steps of prioritising the interactive objects 18 in relation to their distance direction from each other and in relation to the pointer 14's coordinates 12. The interactive objects 18 are sized and moved in relation to the object's priority, so that higher priority objects are larger than lower priority objects and the highest priority object 18.2 (shown in grey) are closer to the pointer 14's coordinates 12, while the lower priority objects are further away. The above steps are repeated every time the coordinates 12 of the pointer 14 change. The method further includes the step of performing an action when the threshold 23 is reached. The priority of an interactive object is a discrete value between 0 to 7 in this example, where 0 indicates the lowest and 7 the highest priority. Alternatively, the priority of an interactive object can be a continuous value between 0 and 1, where 0 indicates the lowest and 1 the highest priority. The highest priority will be given to the interactive object 18 closest to the pointer 14 and the lowest priority to the furthest. When the new coordinates 16 of the interactive objects are calculated the highest priority interactive object 18.2 is enlarged and moved closer to the pointer coordinates 12 while, in relation to their respective priorities, the rest of the interactive objects is shrunk and moved away from the pointer 14 and each other's coordinates. The method, in this example, includes the step of determining the coordinates 16 of the interactive objects 18 relative to each other. In this case the lower priority objects 18 are moved away from the higher priority objects and the pointer 14 according to each objects priority. The highest priority object 18.2 cooperates with the user, while the other objects act evasively. A function is assigned to the thresholds 23 whereby an interactive object, the grey object 18,2 in this case, can be selected when its threshold 23.2 is pierced when the perimeter of 18.2 is reached, for example by crossing the perimeter. The Highest priority object is selected when the coordinates 12 of pointer 14 and coordinates 16 of a prioritised interactive object 18 coincides. An area 19 is allocated wherein the pointer 14's coordinates are representative. The method may further include the step of first fixing or determining a reference point 20 for the pointer, in this case the centre point of area 19. The pointer reference point 20 is repositioned as a new starting point for further navigation on the GUI, for example when the edge of a display space is reached, or when a threshold 23 is pierced, in the case where object 19 is a folder, for example. In other embodiments, the reference point can also be reset or repositioned by a user such as when a pointer object is lifted from a touch sensitive input device.

Referring to FIG. 5 and building on the example in FIG. 4, the method includes the step of first fixing or determining a reference point 20 for the pointer. Directional measurements from the pointer reference 20 to the pointer 14's coordinates 12, indicated by the arrow 30, are used as a parameter in an algorithm to determine object priorities. Distance and direction measurements 32 from the pointer 14's coordinates 12 to an object 18's coordinates 16 is used as a parameter in an algorithm to determine the interaction between the pointer 14 and objects 18. In this example, the directional and distance measurements are respectively angular and radial measures. In this example, the object 18 is moved according to priority determined by direction and the interaction that relates to distance is represented by size changes of the objects 18. The size of the prioritised objects 18 reflects the degree of selection, which in practise causes state changes of an object.

Referring now to FIG. 6 and building on the example in FIG. 1, the thresholds 21 in relation to the space about interactive objects 18, may also preferably be assigned coordinates to be treated as non-visible interactive objects. An area 19 is allocated wherein the pointer 14's coordinates 12 are representative. The method then includes the step of displaying further interactive objects 18.i.j belonging logically in the space between the objects 18 when one of the thresholds 21 associated with space about an object have been activated. The pointer is zeroed to the centre of area 19 and objects 18.i.j takes the place of objects 18.i, which is moved off-screen. A new set of thresholds 23.i.j in relation to the interactive objects 18.i.j and a new set of thresholds 21.i.j in relation to the space about interactive objects 18.i.j are established. The objects 18.i.j and thresholds 21.i.j and 23.i.j will then interact in the same way as the interactive objects 18.i. The objects 18.i.j so displayed grow from non-visible to comparable interactive objects to create the effect of navigating through space and/or into levels beyond the immediate display on the GUI 10. A function is assigned to the thresholds 23 whereby an interactive object, 18.i or 18.i.j in this case, can be selected when a threshold 23 is pierced when reached, for example when the perimeter of an object is crossed. The method further includes the step of first fixing or determining a reference point 20 for the pointer, in this case the centre point of area 19, The pointer reference point 20 may be reset or repositioned as a new starting point for further navigation on the GUI, for example when the edge of a display space is reached, or when a threshold 23 is pierced or when a threshold 21 is activated. In other embodiments, the reference point can also be reset or repositioned by a user such as when a pointer object is lifted from a touch sensitive input device.

Referring now to FIG. 7, the GUI, in accordance with the invention, is generally indicated by reference numeral 10. A representation 14 of a pointer is displayed on the GUI 10 in this case where the input device is not also the display. A method, in accordance with the invention, for human-computer interaction on a GUI 10 includes the steps of determining coordinates 12 of a pointer 14, with, or relative to, an input device, as well as determining the coordinates 16 of interactive objects 18 displayed in on the GUI relative to the coordinates 12 of the pointer 14. In this case, the objects 18 are arranged in a circular manner, such that every direction from the pointer 14's coordinates 12 may point at not more than one object's position coordinates 16. Each object 18 may be pointed at from the pointer 14 by a unique range of angles. A set of thresholds 23 in relation to the interactive objects 18, which coincides with the perimeters of the interactive objects 18 and a set of thresholds 21 in relation to the space about interactive objects 18 are established. The method further includes the steps of prioritising the interactive objects 18 in relation to their distance to the pointer 14. The highest priority is given to the interactive object 18 closest to the pointer 14 coordinates 12 and the lowest priority to the furthest. When the new coordinates 16 of the interactive objects 18 nearest the pointer 14, having the highest priority, are calculated, the interactive objects 18, and their associated thresholds 23 and 21, are moved and resized on the bounds of the circle to provide more space for new objects. The above steps are repeated every time the coordinates 12 of the pointer 14 change. The method further includes the step of performing an action when a threshold 23 or 21 is reached. Interaction with objects is possible whether displayed or not. A function to access objects belonging logically in or behind space between displayed interactive objects is assigned to the first set of thresholds 21, and the function is performed when a threshold 21 is activated when reached. The method then includes the step of inserting an object 26, which belongs logically between existing interactive objects 18. The new object grows from non-visible to comparable interactive objects to create the effect of navigating through space and/or into levels beyond the existing objects. It will further be appreciated that the new objects reacts the same as the existing objects, as described above with regard to movement and sizing. A function is assigned to the threshold 23 whereby an interactive object 18 or 26 can be selected when the threshold 23 is pierced when the perimeter of the objects 18 or 26 is reached, for example by crossing the perimeter. An area 19 is allocated wherein the pointer 14's coordinates are representative. The method further includes the step of first fixing or determining a reference point 20 for the pointer, in this case the centre point of area 19. The pointer reference point 20 may be reset or repositioned as a new starting point for further navigation on the GUI, for example when the edge of a display space is reached, or when a threshold 23 is pierced.

In FIGS. 2-5 and 7, the interactive objects 18 are arranged and displayed in a circular pattern around a centre point. The pointer 14's coordinates can approach the interactive objects 18 from the centre point. The centre point can also be a pointer reference point 20, which can be reset or repositioned as a new starting point from which to start another interaction on the GUI after one interaction has been completed. For example, activating an icon represented by a specific interactive object. It will be appreciated that an arrangement of objects in a circle about the pointer 14 or centre point 20 is an arrangement of objects on the boundary of a convex space. Objects may also be arranged on a segment of the boundary, for example arcs or line segments.

Referring now to FIG. 8, the interactive objects 18 are arranged in a semi-circle about a centred starting reference point 20. The dashed lines indicate some possible thresholds. The pointer reference point 20 may be reset or repositioned as a new starting point for the next stage of navigation, for example when the edge of a display space is reached, or when a threshold is pierced. It will be appreciated that that such a geometry combined with the GUI described above would make navigation on hand held devices possible with the same hand holding the device, while providing for a large number of navigational options and interactions. In addition, such an arrangement limits the area on a touch sensitive screen obscured by a user's hand to a bottom or other convenient edge part of the screen. Once an action is completed the user starts again from the reference point 20, thereby avoiding screen occlusions.

Referring now to FIG. 9, a series of interactions, starting with FIG. 9.1 and terminating in FIG. 9.8, are shown. Objects are arranged in a semi-circle about a centre reference point 20, but it should be appreciated that a circular arrangement would work in a similar way. In this example, a series of thresholds 25, indicated by the dashed line concentric semi-circles, are established in relation to the pointer reference point 20. Each time a threshold is reached, interactive objects, belonging logically in the hierarchy of interactive objects, are displayed as existing objects are moved to make space. Navigation starts with a first selection of alphabetically ordered interactive objects 30.1; to a second level of alphabetically ordered interactive objects 30.2 when threshold 25.1 is reached; to a selection of partial artist names 30.3; to a specific artist 30.4; to a selection of albums 30.5; to a specific album 30.6; to a selection of songs 30.7; to a specific song 30.8, which may be selected. Along the way, as the interaction progress, the pointer is moved only the distance indicated by the dashed trajectory 42 without the need to touch any of the intermediate interactive objects 30.1 to 30.7 with the pointer 14. It should be appreciated that this kind of invention allows for dynamic hierarchical navigation and interaction with an object before that object is reached by a pointer or without selection of an object along the way. A further threshold 23 may be established in relation to interactive object 30.8, which when pierced selects this object.

Referring now to FIG. 10, FIG. 10.1 shows the pointer movement line, or trajectory, 40 to complete a series of point-and-click interactions on a typical GUI. The user starts by clicking icon A, then B and then C. FIG. 10.2 shows the trajectory 42 on the GUI according to the invention, wherein changes in the pointer coordinates interacts dynamically with all the interactive objects to achieve navigation. Movement towards A makes space between existing objects to reveal B. Further movement towards B makes space between existing objects to reveal C. Further movement towards C move and resize the interactive objects based on the distance and/or direction between the pointer and interactive objects. The depicted trajectory 42 is just one of many possible trajectories. FIG. 10 also demonstrates the improvement in economy of movement, 42 is shorter than 40, of human-computer interaction according to the invention.

Referring now to FIGS. 11 to 17, the graphical user interface (GUI), in accordance with the invention, is generally indicated by reference numeral 10. The method for human-computer interaction on a GUI 10, includes the steps of determining or assigning x, y coordinates 12 of interactive objects 14 displayed on the GUI 10 and assigning a virtual negative z coordinate value 16 to the interactive objects displayed on the GUI 10, to create a virtual three-dimensional GUI 10 space extending behind and/or above the display of the touch screen input device 18, in this example. The method further includes determining x, y coordinates of a pointer 20 on a GUI 10 relative to a touch screen input device 18 and determining a corresponding virtual z coordinate value 22 relative to the distance, Z, of a pointer object 24 above the input device. The method then includes the step of prioritising the interactive objects 14 in relation to their coordinate 12 distance to the pointer 20 x, y coordinates and interaction determined in relation to their direction to the virtual z coordinate value 16 of the pointer 20. The interactive objects 14 are then moved according to its priority and moved relative to their interaction according to a preselected algorithm. The method further includes the step of repeating the above steps every time the coordinates 12 and/or virtual z 16 coordinate of the pointer changes.

With reference to FIG. 12, the interactive object 14 is displayed relative to a centre point 26 above the touch screen input device at a specific x, y and Z coordinate. Once an interaction is completed such as touching and selecting an interactive object 14 the user starts again from the reference point 26.

With reference to FIG. 13, a virtual threshold plane is defined above the input device at Z1, which represents the surface of the display. This threshold includes a zeroing mechanism to allow a user to navigate into a large number of zeroed threshold planes by allowing the user to return the pointer object 24 to the reference point 26 after completing an interaction or when the virtual threshold is activated or pierced as discussed below. In this case, as demonstrated in FIGS. 13 to 16, the method includes activating the virtual threshold plane, to allow objects logically belonging in or behind the space, to be approached only when space about interactive objects is navigated, for example when the x, y coordinate of the pointer approaches or is proximate space between interactive objects 14 displayed on the GUI 10. If the pointer's x, y coordinates correspond to the x, y coordinates of an interactive object 14, which is then approached in the z-axis by the pointer object, the threshold is pierced, i.e. not activated, and the object can be selected by touching the touch sensitive input device 18.

In another example of the invention, not shown in the figures, the method includes providing a plurality of virtual threshold planes along the z-axis, each providing a convenient virtual plane in which to arrange interactive objects 14 in the GUI 10, with only the objects in one plane, which corresponds to the plane of the display visible at any one time, with interactive objects 14 on other planes having a more negative z coordinate value than the objects being greyed out or veiled. More positive z valued interactive objects will naturally not be visible on a two-dimensional display.

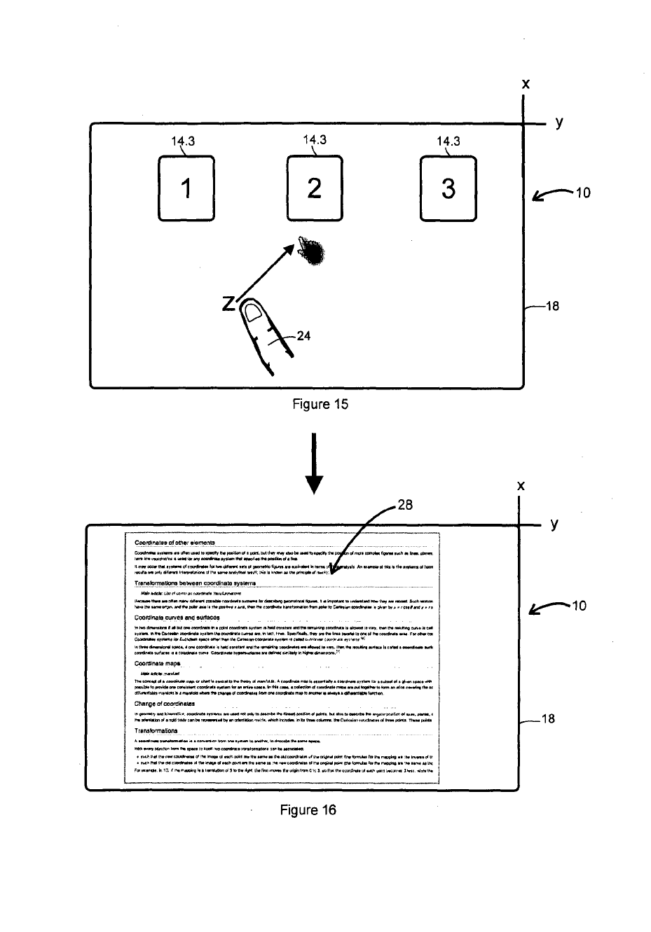

In another embodiment, with reference to FIGS. 13 to 16, to navigate into a number of zeroed threshold planes, a user will move the pointer object 24 to approach space between interactive objects 14.1 along the Z-axis, when the position Z1 is reached, objects 14.2 is displayed in FIG. 13, which follows logically between the interactive objects 14.1. The user then returns the pointer object 24 to the reference point 26. The previous navigation steps are repeated to affect the display of the interactive objects 14.3 between interactive objects 14.2, as shown in FIG. 14. In FIG. 15, the pointer object approaches interactive object 14.3 numbered 2 and then pierce the virtual threshold by touching the object to complete the interaction. The result is that information 28 is displayed in FIG. 16.

In another embodiment, with reference to FIG. 17, a text input device, displayed on a touch sensitive display, provided with a means of three-dimensional input, such as a proximity detector, is navigated. A user will move the pointer object 24 to approach space between interactive objects 14.1, which are in the form of every fifth letter of the alphabet. The user keeps the pointer object 24 at a minimum height above the Z-axis, when the pointer 20 is proximate the space between the interactive objects 14.1, at an established threshold. The interactive objects 14.2 are displayed, showing additional letters that logically fit between the letters 14.1. The user then lowers the pointer object 24 along the Z-axis with the pointer x, y coordinates approaching the letter H, which letter will be resized bigger until the user touches and selects the letter H. The user then returns the pointer object 24 to the reference point 26 at the height Z above input device and the steps are repeated to select another letter.

Referring now to FIG. 18, the GUI, in accordance with the invention, is generally indicated by reference numeral 10. A method for human-computer interaction on 10 includes the steps of determining or assigning x, y coordinates 12 of interactive objects 14 displayed on the GUI 10 and assigning a virtual negative z coordinate value 16 to the interactive objects displayed on the GUI 10, to create a virtual three-dimensional GUI 10 space extending behind and/or above the display of the touch screen input device 18, in this example. The method further includes determining x, y coordinates of a pointer 20 on a GUI 10 relative to a touch input device 18 and determining a corresponding virtual z coordinate value 22 relative to the distance Z of a pointer object 24 above the input device. The method then includes the step of prioritising and determining interaction with the interactive objects 14 in relation to their coordinates 12 distance and direction to the pointer and in relation to their distance and direction to the virtual z coordinate value 16 of the pointer 20. The method further includes the step of determining the direction and movement 23 of the pointer object 24 in terms of its x, y and Z coordinates. The interactive objects 14 are then sized and/or moved relative to their priority according to a preselected algorithm and using the determined direction and movement of the pointer object 24 in an algorithm to determine how a person interacts with the GUI. The method then includes the step of repeating the above steps every time the x, y coordinates 12 and/or virtual z 16 coordinates of the pointer 20 changes.

Referring now to FIG. 19, the method, in one example, includes the step of determining the orientation and change of orientation of the pointer object 24, above fixed x, y coordinates 30 located on the zero z value, in terms of changes in its x, y and Z coordinates. The user can now navigate around the virtual three-dimensional interactive objects 14. In addition, a joystick, for playing games, and mouse movement inputs can be simulated. The x, y coordinates can be fixed, by clicking a button for example, from which the orientation can be determined. It should also be appreciated that the x, y, Z coordinates of the pointer object above the fixed x, y coordinates will vary, in this case. A fixed pointer reference 32 is displayed and a movable pointer 34 can be displayed.

Referring now to FIGS. 20 to 23, the GUI in accordance with the invention, is generally indicated by reference numeral 10. The GUI 10 is configured to reference points 16 in a virtual space and reference a point 12 in the virtual space at which a user is navigating at a point in time, called the pointer 14. A processor then calculates interaction of the points 16 in the virtual space with the pointer's point 12 in the virtual space according to an algorithm according to which the distance between points closer to the pointer is reduced. The algorithm, in this example causes the virtual space to be contracted with regard to closer reference points 16 and expanded with regard to more distant reference points 16. The calculating step is repeated every time the pointer is moved. At some of the referenced points 16 in the virtual space further characteristics are assigned to act as a cooperative target or a cooperative beacon, both denoted by 18, and an object (a black discs in this case) is displayed to represent these at the points. The cooperative target or cooperative beacon is interactive and may be treated as an interactive object, as described earlier in this specification. Objects, targets, beacons or navigation destinations, in the space should naturally follow the expansion and contraction of space.

Referring now to FIG. 24, in this example points 16 are referenced in a circular pattern around a centre referenced point 20. To certain points interactive objects 18 are assigned and displayed in a circular pattern around the referenced point 20. The pointer or pointer object (not shown) can approach the interactive objects 18 and points 16, representing space between the interactive objects, from the reference point 20. Some of the points 16 can, in another embodiment of the invention, be assigned an interactive object, which is not displayed until the pointer reaches an established proximity threshold in relation to the reference point. In this example, the arrangement is in a semi-circle and it will be appreciated that such a geometry combined with the GUI described above would make navigation on hand held devices possible with the same hand holding the device, while providing for an large number of navigational options and interactions. In addition, such an arrangement can limit the area on a touch sensitive screen obscured by a user's hand to a bottom or other convenient edge part of the screen. Once an interaction is completed the user starts again from the reference point 20 thereby further limiting obscuring the screen. In an even further embodiment of the invention, distance and/or angular measurements from a pointer, starting at the reference point 20, to the interactive objects 18 and points 16 are used in an algorithm to calculate interaction.

Referring now to FIG. 25, the GUI, in accordance with the invention, is generally indicated by reference numeral 10. A method, in accordance with the invention, for human-computer interaction on a GUI 10 includes the steps of referencing points 16 in a virtual space in a circular pattern about a centre referenced point 20 and referencing a point 12 in the virtual plane at which a user is navigating at a point in time, called the pointer 14. Certain of these points 16 are chosen and interactive objects 18 are assigned to them. These objects are displayed in a circular pattern around the referenced point 20. The method then includes the step of calculating interaction of the points 16 in the virtual space with the pointer's point 12 in the virtual space according to an algorithm according to which the distance between point 16 closer to the pointer's point 12 is reduced. The pointer 14 or pointer object (not shown) can approach the interactive objects 18 and points 16, representing space between the interactive objects, from the reference point 20. The algorithm includes the function to prioritise the interactive objects 18 in relation to their distance to the pointer 14 and moving the interactive object 18 (shown in grey) nearest to the pointer having the highest priority closer to the pointer and repeating the above steps every time the position of the pointer's point 12 changes. The highest priority will be given to the interactive object 18 closest to the pointer 14 and the lowest priority to the furthest. When the new position of the points 16 of the interactive objects are calculated the highest priority interactive object 18 will be moved closer to the pointer 14 and so forth. The interactive objects 18 can also be defined as cooperative targets, or beacons when they function as navigational guiding beacons. Thresholds are established in a similar way as described in earlier examples.

Referring now to FIG. 26, the GUI in accordance with the invention, is generally indicated by reference numeral 10. A method, in accordance with the invention, for human-computer interaction on a GUI 10 includes the steps of referencing points 16 in a virtual space in a circular pattern about a centre referenced point 20 and referencing a point 12 in the virtual space at which a user is navigating at a point in time, called the pointer 14. Certain of these points 16 are chosen and interactive objects 18 are assigned to them. These objects are displayed in a circular pattern around the centre referenced point 20. The method then includes the step of calculating interaction of the points 16 in the virtual plane with the pointer's point 12 in the virtual plane according to an algorithm so that the distance between a point 16 closest to the pointer's point 12 is reduced and the distances between points further away from the pointer's point are increased along the circle defined by the circular arrangement. The pointer can approach the interactive objects 18 and points 16, appearing as space between the interactive objects, from the reference point 20. The algorithm includes the function to prioritise the interactive objects 18 in relation to their distance to the pointer 14 and moving the interactive object 18 (shown in grey) nearest to the pointer having the highest priority closer to the pointer and repeating the above steps every time the position of the pointer's point 12 of the pointer 14 changes. The highest priority will be given to the interactive object 18 closest to the pointer 14 and the lowest priority to the furthest. When the new position of the points 16 of the interactive objects are calculated, the highest priority interactive object 18 will be moved closer to the pointer 14 and the remaining points will be moved further away from the pointer's point 12. Thresholds are established in a similar way as described in earlier examples.

Referring now to FIG. 27, the space about interactive objects or a point 22 in the space between interactive objects 18, in a further example, may also preferably be assigned a function to be treated as a non-visible interactive object. The method may then include the step of displaying an object 26 or objects when a threshold in relation to points 22 is reached. These objects 26 and the point 22 in space between will then interact in the same way as the interactive objects 18. New, or hidden, objects 26 which logically belong between existing interactive objects 18 are displayed when the objects 18 adjacent the point 22 in space have been moved and resized to provide more space to allow for the new or hidden objects 26 to be displayed between the existing adjacent objects. The object(s) 26 so displayed grow from non-visible to comparable interactive objects from the point of the coordinates 24 to create the effect of navigating through space and/or into levels beyond the immediate display on the GUI 10. Thresholds are established in a similar way as described in earlier examples. New points 24 in the virtual space are referenced (activated) when an established threshold is activated. These points becomes a function of an algorithm and now acts similarly to points 16.

Referring now to FIG. 28, a method for recursively navigating hierarchical data, in accordance with the invention, for human-computer interaction on a GUI 10 includes the steps of determining coordinates 12 of a pointer 14 with, or relative to, an input device, as well as determining display coordinates 16 and interaction coordinates 17 of interactive objects 18. Interactive objects are displayed on the GUI 10 relative to the coordinates 12 of the pointer 14. The interactive objects 18 may be arranged in a circular manner, a ring-shaped figure (annulus) around a centre point, such that every direction from the pointer 14's coordinates 12 may point at not more than one object 18's interaction coordinates 17. Each object 18 may be pointed at from the pointer 14 by a range of angles. A set of thresholds 23, which coincides with the inner arc of an interactive object's initial perimeter, is established in relation to each interactive object's interaction coordinates 17. The method includes the step of prioritising the interactive objects 18 in relation to the distance and/or direction between the pointer 14's coordinates 12 and the object 18's interaction coordinates 17. The interactive objects 18 are moved and sized in relation to each object's priority, so that higher priority objects occupy a larger proportion of the annulus than lower priority objects. The above steps are repeated every time the coordinates 12 of the pointer 14 change. The method further includes the step of performing an action when the threshold 23 is reached. The method may also include the step of fixing or determining a reference point 20 for the pointer 14, for example 20.1 in FIG. 28.1 is a first reference point for navigation. The pointer reference point 20 may be reset or repositioned to serve as a new starting point, for example when a threshold 23 is pierced, for further navigation on the GUI. Reference point 20.2 in FIG. 28.3 is an example of a second reference point for navigation. A navigation level indicator 50 may be established and initially centred on the reference point 20. FIG. 28.1 shows the initial arrangement of the first level of a hierarchical data structure that contains eight items. An interactive object represents each data item, here indicated by numerals 18.1 to 18.8. Display coordinates 16.1 to 16.8, interaction coordinates 17.1 to 17.8 and thresholds 23.1 to 23.8 are also indicated. The level indicator 50 may indicate the current hierarchical navigation level by some means, for example numerically. The level indicator may further track the pointer 14's movement and update its position to be centred on the pointer 14's coordinates 12. In this example the dotted path 42 indicates the pointer's movement, its trajectory, over time. The priority of an interactive object is discrete values between 0 to 7 in the initial arrangement of the example, ordered to form a ranking, where 0 indicates the lowest and 7 the highest priority. Alternatively, the priority of an interactive object may be a continuous value between 0 and 1, where 0 indicates the lowest and 1 the highest priority. The highest priority will be given to the interaction coordinate 17 closest to the pointer 14's coordinate and the lowest priority to the furthest. In this example the interaction coordinates 17 of an object 18 may be different from the object's display coordinates 16. The interaction coordinates 17 may be used in a function or algorithm to determine the display coordinates 16 of an object. When the new display coordinates 16 of the interactive objects are calculated, the location of the display coordinates 16 is updates to maintain a fixed distance from the pointer's coordinates 12, while allowing the direction between the pointer's coordinates 12 and the display coordinates 16 to vary. This has the effect of maintaining the annular arrangement of interactive objects 18 during interaction. Furthermore, higher priority interactive objects 18 will be enlarged and lower priority objects will be shrunk. The next items in the hierarchical data structure may be established as new interactive objects. The new object's display coordinates, interaction coordinates and thresholds are established and update in exactly the same manner as existing interactive objects. These new interactive objects may be contained within the bounds of the parent interactive object. The size and location of the new interactive objects may be updated in relation to the parent interactive object's priority every time the pointer 14's coordinates 12 changes. FIG. 28.2 shows the arrangement after the pointer moved as indicated by trajectory 42. Along with the first level of eight items, the second level of hierarchical items is shown for the interactive objects with the highest priority, 18.1, 18.2 and 18.8 in this case. The new interactive objects, their display coordinates, interaction coordinates and thresholds are indicated by sub-numerals. For example, objects are indicated by 18.1.1 to 18.1.4 and display coordinates by 16.1.1 to 16.1.4 for parent object 18.1. In this case 18.1 has the highest priority due to its proximity to the pointer 14. Consequently, its children objects 18.1.1 to 18.1.4 are larger than other object's children. A function is assigned to the thresholds 23 whereby an interactive object is selected and a next level for navigation is established, based on the selected object, when a threshold 23 is pierced, for by crossing a perimeter. As the pointer moves closer to a threshold 23, the highest priority interactive object takes up more space in the annular arrangement, until it completely takes over and occupies the space. This coincides with the highest priority item's threshold 23 being pierced. When the next level of navigation is established a new pointer reference point 20 is established at the pointer's location. For the selected interactive object, new interaction coordinates 17 and thresholds 23 are established for its children and updated as before. A new interactive object may be established to represent navigation back to previous levels. This object behaves in the same way as objects that represent data, but does not display child objects. FIG. 28.3 shows the initial arrangement, around a new pointer reference point 20.2, of a second level of hierarchical objects, 18.1.1 to 18.1.4, after interactive object 18.1 has been selected. The new interaction coordinates 17.1.1 to 17.1.4 and thresholds 23.1.1 to 23.1.4 are indicated. An interactive object 18.1.B that can be selected to navigate back to the previous level, along with its associated display coordinates 16.1.B, interaction coordinates 17.1.B and threshold 23.1.B, is also shown. When 18.1.B is selected, an arrangement similar to that of FIG. 28.1 will be shown. Note that the interaction coordinates 17 and its associated thresholds 23 does not change during navigation until one of the thresholds 23 is pierced and a new navigation level is established. In some embodiments, the reference point 20 may also be reset or repositioned by a user, for example by using two fingers to drag the annular arrangement on a touch sensitive input device.

Referring now to FIG. 29, a method, in accordance with the invention, for human-computer interaction on a GUI 10 includes the steps of determining coordinates 12 of a pointer 14 with, or relative to, an input device, as well as determining display coordinates 16 and interaction coordinates 17 of interactive objects 18. Interactive objects are displayed on the GUI 10 relative to the coordinates 12 of the pointer 14. The interactive objects 18 are arranged in a linear manner, such that every direction from the pointer 14's coordinates 12 point at not more than one object 18's interaction coordinates 17. Each object's interaction coordinates 17 is pointed at from the pointer 14's coordinates 12 by a unique range of angles. The method further includes the step of prioritising the interactive objects 18 in relation to the distance between the pointer's coordinates 12 and the object 18's interaction coordinates 17. The interactive objects 18 are moved and sized in relation to each object's priority, so that higher priority objects are made larger and lower priority objects made smaller. The above steps are repeated every time the coordinates 12 of the pointer 14 change. The method also includes the step of fixing or determining a reference point 20 for the pointer 14. A set of thresholds 25, which are parallel to a y-axis, is established in relation to the reference point 20. The method further includes the step of performing an action when one of the thresholds 25 is reached. FIG. 29.1 shows a list of images 60, an alphabetical guide 61 and a text list 62. Each image is an interactive object, and represents one of 60 albums available on a device. The albums are alphabetically organised, first by artist name and then by album name. The interaction points 17 of the interactive items 18 are distributed with equal spacing in the available space on the y-axis. The alphabetical guide serves as a signpost for navigation and indicates the distribution of artist names. Letters that have a lot of artists that starts with that letter, “B” and “S” in this case”, has more space than letters with little or no artists, “I” and “Z” in this case. The content of the text list 62 depends on the location of the pointer, which can trigger one of the thresholds 25. Display coordinates 16.1 to 16.60, interaction coordinates 17.1 to 17.60 and thresholds 25.1 to 25.3 are also indicated. In the initial arrangement with no pointer 14 present, the interactive items all have the same size, while the y-axis coordinate value of their display coordinates 16 and interaction coordinates 17 are the same. If the y-axis value of the pointer 14's coordinates 12 are less than the value of threshold 25.1, no dynamic interaction with the interactive objects 18 occur. If the y-axis value of the pointer 14's coordinates 12 are less than the value of threshold 25.2, the artist name of each object is displayed in the text list 62. If the y-axis value of the pointer 14's coordinates 12 is more than the value of threshold 25.2 and less than the value of threshold 25.3, the artist name and album names of each object is displayed in the text list 62. If the y-axis value of the pointer 14's coordinates 12 is more than the value of threshold 25.3, the album name and track title of each object are displayed in the text list 62. The priority of an interactive object is a continuous value between 0 and 1, where 0 indicates the lowest and 1 the highest priority. The highest priority will be given to the interaction coordinate 17 closest to the pointer 14's coordinate and the lowest priority to the furthest. In this example the interaction coordinates 17 of an object 18 are different from the object's display coordinates 16. The interaction coordinates 17 are used in a function or algorithm to determine the display coordinates 16 of an object. When the new display coordinates 16 of the interactive objects are calculated, a function is applied that adjusts the display coordinates 16 as a function of the pointer 14's coordinates 12, the object's interaction coordinates 17 and the object's priority. The functions are linear. Furthermore, highest priority interactive object 18 will be enlarged and lower priority objects will be shrunk. Functions are assigned to the thresholds 25 whereby different text items are display in the text list 62 when one of the thresholds is reached. FIG. 29.2 shows the arrangement of the interactive objects after the pointer 14 moved as indicated. The pointer 14 is closest to interaction coordinate 17.26. The interactive objects have moved and resized in a manner that keeps the highest priority object on the same y-axis as the object's interaction coordinate, while moving other high priority objects away from the pointer compared to the object's interaction y-axis coordinate and also move low priority items closer to the pointer 14 compared to the object's y-axis interaction coordinate. This has the effect of focusing on the closest interactive object (album) 18.26, while expanding interactive objects 18 close to the pointer 14 and contracting those far from the pointer 14. Threshold 25.2 has been reached and the artist name and album name are displayed in the text list 62 for each object. The text list 62 also focuses on the objects in the vicinity of the pointer 14. FIG. 29.3 shows the arrangement of the interactive objects after the pointer 14 moved as indicated. The pointer 14 has moved more in the x-axis direction, but is still closest to interaction coordinate 17.26. The interactive objects have moved and resized as before. Threshold 25.3 has been reached and the album name and track title are displayed in the text list 62 for each object. The text list 62 again focuses on the objects in the vicinity of the pointer 14. The method may further include the steps of updating the visual representation of a background or an interactive object when a threshold is reached. For example, when reaching threshold 25.2, the album artwork of the highest priority interactive object 18 may be displayed in the background of the text list 62. In another example, when reaching threshold 25.3, the transparency level of interactive objects 18 may be changed in relation to their priority so that higher priority items are more opaque and lower priority items are more transparent.

In FIG. 30 and FIG. 31 shows examples of geometries that can be used to determine distance and direction measurements as inputs or parameters for a function and/or algorithm. Distance measurements can be taken from a central point to a pointer or from the pointer to an object to determine either priority and/or another interaction with an object. Angular measurements can be taken from a reference line which intersects the centre point to a line from the centre point to the pointer or angular measurements can be taken from a reference line which intersects the pointer and a line from the pointer to the object to determine either priority and/or another interaction with an object.

FIG. 32 shows examples of two- and three-dimensional convex shapes. Utility can be derived by arranging objects, or the interaction coordinates of objects, on at least a segment of the boundary of a convex shape. For example, this ensures that, from the pointer, each directional measure may point at not more than one object's position or interaction coordinate. Thereby allowing unique object identification.

In FIGS. 33 to 36, the GUI 10 is represented twice to reduce clutter in the diagrams, while demonstrating the relationship between an object's display and interaction coordinates. Firstly, showing in 10.1 the interaction coordinates 17 of the interactive objects 18, and secondly showing in 10.2 the display coordinates 16 of the interactive objects 18. It will be appreciated that it is important to be able to have the same object with different interaction and display coordinates. Interaction coordinates are not normally visible to the user. 10.1 is called the GUI showing interaction coordinates, and 10.2 the GUI showing display coordinates. The GUI's interaction coordinate representation 10.1 demonstrates the interaction between a pointer 14 and interactive objects 18's interaction coordinates 17. The GUI's display coordinate representation 10.2 shows the resulting visual effect when the interaction objects 18 are resized and their display coordinates 16 are moved in accordance with the invention. 10.1 also shows the initial interaction sizes of the interactive objects. The pointer 14, pointer coordinates 12, pointer reference point 20 and interactive objects 18 are shown in both GUI representations.

Referring now to FIG. 33, a method, in accordance with the invention, for human-computer interaction on a GUI 10, showing interaction coordinates in 10.1 and display coordinates in 10.2, includes the steps of determining coordinates 12 of a pointer 14 with, or relative to, an input device and storing and tracking the movement of the pointer 14 over time. The method includes the steps of determining display coordinates 16 and interaction coordinates 17 of interactive objects 18. A pointer reference point 20 is established and shown in both representations 10.1 and 10.2. Interactive objects 18.i, where the value of i range from 1 to 12 in this example, are established with uniform sizes wᵢ; relative to the pointer coordinates 12. The interactive objects 18 are initially assigned regularly spaced positions rᵢ on a circle around reference point 20. The method further includes the step of prioritising the interactive objects 18 in relation to the distance between the pointer 14's coordinates 12 and the i'th object's interaction coordinates 17.i, indicated by rᵢₚ. The distance and direction between the pointer 14 and the reference point 20 is indicated by rₚ. The interactive objects 18 are moved, so that the display coordinates 16 of higher priority are located closer to the pointer 14, while the display coordinates 16 of lower priority objects are located further away. The interactive objects 18 are sized in relation to each object's priority, so that higher priority objects become larger compared to lower priority objects. The above steps are repeated every time the coordinates 12 of the pointer 14 change. The relative distance rᵢₚ with respect to the pointer 14 may be different for each interaction object 18.i. This distance is used as the priority of an interactive object 18.i. A shorter distance therefore implies higher priority. Applying the functions below yields different sizes and shifted positions 16.i for the objects 18.i in 10.2 compared to their sizes and interaction coordinates 17.i in 10.1. The size Wᵢ of an interactive object in 10.2 may be calculated as follows:

$${W}_{i} = \frac{mW}{1 + ( m - 1 ) {r}_{ip}^{q}} ,$$

where m is a free parameter determining the maximum magnification and q is a free parameter determining how strongly magnification depends upon the relative distance. The function family used for calculating relative angular positions may be sigmoidal, as follows. θ₉ is the relative angular position of interactive object 18.i with respect to the line connecting the reference point 20 to the pointer's coordinates 12. The relative angular position is normalized to a value between −1 and 1 by calculating

$${u}_{ip} = \frac{{θ}_{ip}}{π} .$$

Next the value of vᵢₚ is determined as a function of uᵢₚ and rₚ, using a piecewise function based on ue^{u} for 0≦u<1/N, a straight line for 1/N≦u<2/N and 1−e^{-u} for 2/N≦u≦1, with rₚ as a parameter indexing the strength of the non-linearity. The relative angular position φᵢₚ of display coordinates 16.i, with respect to the line connecting the reference point 20 to the pointer 14 in 10.2, is then calculated as φᵢₚ=π [symbol] vᵢₚ. FIG. 33.1 shows the pointer 14 in the neutral position with the pointer coordinates 12 coinciding with the pointer reference coordinates 20. The relative distances rᵢₚ between the pointer coordinates 12 and the interaction coordinates 17.i of interactive objects 18.i are equal. This means that the priorities of the interactive objects 18.i are also equal. The result is that the interactive objects 18 in 10.2 have the same diameter W, and that the display coordinates 16.i are equally spaced in a circle around the reference point 20. FIG. 33.2 shows the pointer 14 displaced halfway between the reference point 20 and interactive object 18.1's interaction coordinates 17.1. The resultant object sizes and placements are shown in 10.2. The sizes of objects with higher priority (those closest to the pointer 14) are increased, while objects with lower priority are moved away from the pointer reference line. Note that the positions of the interaction 17 and display 16 coordinates are now different. FIG. 33.3 shows the pointer 14 further displaced to coincide with the location of interaction coordinate 17.1. The sizes of objects with higher priority are further increased, while objects with lower priority are moved even further away from the pointer 14 compared to the arrangement in FIG. 33.2. FIG. 33.4 shows a case where the pointer 14 is displaced to lie between the interaction coordinates 17.1 and 17.2. The size of interactive objects 18.1 and 18.2 in 10.2 are now the same: W₁=W₂. The angular separation between the objects and the pointer line also has the same value, but with opposite signs: φ₁ₚ=−φ₂ₚ.

Referring now to FIG. 34, a method, in accordance with the invention, for human-computer interaction on a GUI 10, showing interaction coordinates in 10.1 and display coordinates in 10.2, includes the steps of determining coordinates 12 of a pointer 14 with, or relative to, a three-dimensional input device and storing and tracking the movement of the pointer 14 over time. The method includes the step of establishing a navigable hierarchy of interactive objects 18. Each object is a container for additional interactive objects 18. Each level of the hierarchy is denoted by an extra subscript. For example, 18.i denote the first level of objects and 18.i.j the second. The method includes the steps of determining separate display coordinates 16 and interaction coordinates 17 of interactive objects 18. The method includes the step of prioritising the complete hierarchy of interactive objects, 18.i and 18.i.j, in relation to the distance between the pointer 14's coordinates 12 and the object's interaction coordinates 17.i or 17.i.j, denoted respectively by rᵢₚ by rᵢⱼₚ. Objects 18 with interaction coordinates 17 closest to the pointer 14 have the highest priority. The method includes the step of establishing thresholds in relation to the z coordinate in the z-axis. These thresholds trigger a navigation action up or down the hierarchy when reached. The visibility of interactive objects 18 are determined by the current navigation level, while the size and location of objects are determined by an object's priority. Higher priority objects are larger than lower priority objects. The location of visible objects 18 are determined by a layout algorithm that takes into account structural relationships between the objects 18 and the object sizes. The method further includes a method, function or algorithm that combines the thresholds, the passage of time and pointer 14's movement in the z-axis to dynamically navigate through a hierarchy of visual objects. The above steps are repeated every time the coordinates 12 of the pointer 14 change. The interactive objects to be included may be determined by a navigation algorithm, such as the following:
1. If no pointer 14 is present, establish interactive coordinates 17 and display coordinates 16 for all interactive objects 18 in the hierarchy. Assign equal priorities to all interactive objects 18 in the hierarchy.
2. If a pointer 14 is present, establish interactive coordinates 17 and display coordinates 16 for all interactive objects 18 in the hierarchy based on the z coordinate of the pointer 14 and the following rules:
   a. If z<zₜₑ, where zₜₑ is termed the hierarchical expansion threshold, select the object 18 under the pointer coordinates 12 and let it, and its children, expands to occupy all the available space.
      i. If an expansion occurs, do not process another expansion unless:
         1. a time delay of t_{d} seconds has passed, or
         2. the pointers z-axis movement direction has reversed so that z>zₜₑ+z_{hd}, where z_{hd} is a small hysteretic distance and z_{hd}<(z_{tc}−z_{ze}), with z_{tc} as defined below.
   b. If z>z_{tc}, where z_{tc} is termed the hierarchical contraction threshold, contract the current top level interactive object 18 and its children, then reintroduce its siblings.
      i. If a contraction occurred, do not process another contraction unless:
         1. a time delay of t_{d} seconds has passed, or
         2. the pointer's z-axis movement direction has reversed so that z<z_{tc}−z_{hd}, where z_{hd} is as defined before.
   c. Note that zₜₑ<z<z_{tc}.

In this example a two level object hierarchy with four parent objects, denoted by 18.1 to 18.4, each with four child objects, denoted by 18.i.j, where j can range from 1 to 4, is used. The interactive objects are laid out, in 10.1, in a grid formation, so that sibling objects are uniformly distributed over the available space and children tend to fill the space available to their parent object. Each object in 10.1 is assigned a fixed interaction coordinate, 17.i or 17.i.j, centered within the object's initial space. The display coordinates 16 and size (layout) of the interactive objects 18 in each level of the hierarchy are determined as a function of the sibling object's priority. One possible layout algorithm is:
1. A container that consists of a number of cells, laid out in a grid, is used. A cell may hold zero or one interactive object. The layout container has width w_{c} and height H_{c}. It occupies the available visual space, but is not displayed.
2. Assign a size factor of sfᵢ=1 for each cell that does not contain an object.
3. Calculate a relative size factor sfᵢ for each cell that contains on object, as a function of the object priority. In this case a normalised relative distance rᵢₚ. The function for the relative size factor may be:

$${sf}_{i} = \frac{{sf}_{ma x}}{1 + ( \frac{{sf}_{ma x}}{{sf}_{m i n}} - 1 ) \cdot {r}_{ip}^{q}} , \qquad ( Equation 34.1 )$$

where sfₘᵢₙ is the minimum allowable relative size factor with a range of values 0<sfₘᵢₙδ1, sfₘₐₓ is the maximum allowable relative size factor with a range of values sfₘₐₓ≧1 and q is a free parameter determining how strongly the relative size factor magnification depends upon the normalised relative distance r_{ip.}
4. Calculate the width W_{c} object 18.i as a function of all the relative size factors contained in the same row as the object. A function for the width may be:

$${W}_{c} = \frac{{W}_{c} \cdot {sf}_{i}}{{\sum }_{i = a}^{b} {sf}_{i}} , \qquad ( Equation 34.2 )$$

where a is the index of the first cell in a row and b is the index of the last index in a row.
5. Calculate the height width H_{c} of object 18.i as a function of all the relative size factors contained in the same column as the object. A function for the height may be:

$${H}_{c} = \frac{{H}_{c} \cdot {sf}_{i}}{{\sum }_{i = a}^{b} {sf}_{i}} , , \qquad ( Equation 34.3 )$$

where a is the index of the first cell in a column and b is the index of the last index in a column.
6. Calculate positions for each object by sequentially packing them in the cells of the container.
7. Objects 18.i with larger relative size factors sfᵢ are displayed on top of virtual objects with smaller relative size factors.

FIG. 34.1 shows an initial case where no pointer 14 is present. This condition triggers navigation Rule 1. Using the initial arrange of objects and the described layout algorithm, the hierarchy of interactive objects 18 as shown in 10.1, leads to the arrangements of the interactive objects 18 as shown in 10.2. In this case all interactive objects 18 have the same priority and therefore the same size. In FIG. 34.2, a pointer 14 with coordinates x, y and zₐ, with zₐ>z_{tc}, is introduced. This condition triggers navigation Rule 2. The resulting arrangement of the interactive objects 18 is shown in 10.2. In this case, all the interactive objects in the data set, 18.i and 18.i.j, are visible. Object 18.1 is much larger than its siblings 18.2 to 18.4, due to its proximity to the pointer 14. Inside the bounds of object 18.1, one of its children 18.1.1, is much larger than its siblings 18.1.2 to 18.1.4, again due to its proximity to the pointer 14. FIG. 34.3 shows the pointer 14 to new coordinates x, y and z_{b}, with z_{b}<zₐ and z_{b}<zₜₑ. This condition triggers navigation Rule 2.a. Navigation down the hierarchy, into object 18.1, leads to the layout of interaction objects, 18.1 and its children 18.1.j, as shown in 10.1. Object 18.1's siblings, 18.2 to 18.4, were removed from 10.1, while its children expand to occupy all the available space. After applying the described layout algorithm, the interactive objects 18.1 and 18.1.j are arranged as shown in 10.2. Object 18.1.1 is much larger than its siblings (18.1.2 to 18.1.4) due to its proximity to the pointer 14. FIG. 34.4 shows pointer 14 at the same coordinates (x, y and z_{b}) for more than t_{d} seconds. This condition triggers navigation Rule 2.a.i.1. Navigation down the hierarchy, into object 18.1.1, leads to the layout of interaction objects, 18.1 and 18.1.1, as shown in 10.1. Object 18.1.1's siblings, 18.1.2 to 18.1.4, were removed from 10.1, while the object expands to occupy all the available space. After applying the described layout algorithm, the interactive objects 18.1 and 18.1.1 are arranged as shown in 10.2. Object 18.1.1 now occupies almost all the available space in 10.2. In a further case, a pointer 14 is introduced at coordinates x, y and zₐ, with zₐ>zₜₑ. This leads to the arrangement of objects 18.i and 18.i.j in 10.1 and 10.2, as shown before in FIG. 34.2. Next, the pointer 14 is moved to new coordinates x, y and z_{b}, with z_{b}<zₐ and zₕ<zₜₑ. This leads to the arrangement of objects 18.1 and 18.1.j in 10.1 and 10.2, as shown before in FIG. 34.3. The pointer 14's movement direction is now reversed to coordinates x, y and z_{c}, with z_{b}<z_{c}<zₐ and z_{c}>zₜₑ+z_{td}. The pointer 14's movement direction is again reversed to coordinates x , y and z_{b}, with z_{b}<zₜₑ. This sequence of events triggers Rule 2.a.i.2, which leads to the arrangement of objects 18.1 and 18.1.1, in 10.1 and 10.2, as shown before in FIG. 34.4. The pointer 14's movement direction is again reversed to coordinates x, y and z_{d}, with z_{b}<z_{c}<z_{d}<zₐ and z_{d}>z_{tc}. This sequence of events triggers Rule 2.b, which leads to the arrangement of objects 18.1 and 18.1.j, in 10.1 and 10.2, as shown before in FIG. 34.3. If the pointer 14 is maintained at the same coordinates (x, y and z_{d}) for more than t_{d} seconds, Rule 2.b.i.1 is triggered. Otherwise, if the pointer 14 movement direction is reversed to coordinates x, y and zₑ, with zₑ<z_{d} and zₑ<z_{tc}<z_{td}, Rule 2.b.i.2 is triggered. Both these sequence of events lead to the arrangement of 18.i and 18.i.j, in 10.1 and 10.2, as shown before in FIG. 34.2. The method may also include the step of changing the visual representation of the pointer according to its position along the z-axis, Z-axis or its position relative to a threshold. For example, the pointer's size may be adjusted as a function of Z so that the pointer's representation is large when the pointer object is close to the touch surface and small when it is further away. Also, the pointer representation may change to indicate navigation up or down the hierarchy when the pointer coordinate's z value is close to one of the navigation thresholds. The method may further include the step of putting in place a threshold established in relation to time, when the pointer coordinates remain static within certain spatial limits for a predetermined time. As an example, additional information may be displayed about an interactive object underneath the pointer coordinates if such a threshold in time has been reached.

Referring now to FIG. 35, a method, in accordance with the invention, for human-computer interaction on a GUI 10, showing interaction coordinates in 10.1 and display coordinates in 10.2, includes the steps of determining coordinates 12 of a pointer 14 with, or relative to, an input device and tracking the movement of the pointer 14 over time. As shown in FIG. 35.1, a first set of N interactive objects 18.i is established. Separate display coordinates 16.i and interaction coordinates 17.i of interactive objects 18i. The location and size of the interaction objects 18.i in 10.1 are chosen so that the objects are distributed equally over the space. The interaction coordinates 17.i are located at the centres of the objects. The initial display coordinates 16.i coincides with the interaction coordinates 17.i. FIG. 35.1 shows a case where no pointer 14 is present. The initial set of 16 interactive objects 18.1 to 18.16 is laid out in a square grid formation. In FIG. 35.2 a pointer 14 is introduced with coordinates 12 located over object 18.16. The interactive objects 18.i are arranged as before. If pointer 14's coordinates 12 falls within the bounds of an interactive object and a selection is made, the object will emphasize the selected object, while de-emphasizing the rest. In this example, the selected object 18.16 is emphasized in 10.2 by enlarging it slightly, while all other objects, 18.1 to 18.15, is de-emphasised by increasing their grade of transparency. If the pointer coordinates 12 stays within the bounds of the same object in 10.1 for longer than a short time period t_{d}, a second set of interactive objects is introduced. A first pointer reference point 20.1 is established on the interaction coordinates of the selected object. FIG. 35.3 shows a case where the pointer coordinates 12 stayed within the bounds of interactive object 18.16 for longer than t_{d} seconds. In this case, objects 18.1 to 18.15 are removed, while secondary objects 18.16.j, with 1≦j≦3, are introduced. Display coordinates 16.16.j and interaction coordinates 17.16.j are established for the secondary objects 18.16.j. The objects are arranged at fixed angles θⱼ and at a constant radius r_{d} from the reference point 20.1 in 10.1. Priorities are calculated for each of the secondary objects 18.16.j, based on a relation between the distances between reference point 20.1 and objects 18.16.j, and the pointer coordinates 12. Higher priority objects are enlarged and moved closer to the reference point 20.1. Thresholds 23.16.j in relation to the secondary objects are established. An action can be performed when a threshold 23.16.j is crossed. A third set of interactive objects 18.16.j.k, each related to the objects in the second set 18.16.j, are introduced. A second pointer reference point 20.2 is established at the top left corner of 10.1 and 10.2. Priorities are calculated for each of the tertiary objects 18.16.j.k, based on a relation between the reference point 20.2 and the pointer coordinates 12. Higher priority objects are enlarged and moved away from the reference point 20.2. A number of relations are calculated each time the pointer coordinates 12 changes:
a vector \vec{r}₁ₚ between reference point 20.1 and pointer coordinates 12,
a vector \vec{r}₂ₚ between reference point 20.2 and pointer coordinates 12,
a set of vectors \vec{r}₁ⱼ between reference point 20.1 and the interaction coordinates 17.16.j of the secondary virtual objects 18.16.j,
a set of vectors \vec{r}ₚⱼ₁ that are the orthogonal projections of vector \vec{r}₁ₚ onto vectors \vec{r}_{1j.}

The projection vectors \vec{r}ₚⱼ₁ are used to determine object priorities, which in turn is used to perform a function or an algorithm to determine the size and display coordinates of the secondary objects 18.16.j in 10.2. Such a function or algorithm may be:
Isomorphically map an object's size in 10.1 to 10.2.
Objects maintain their angular θⱼ coordinates.
Objects obtain a new distance r_{dj} from reference point 20.1 for each interactive object 18.16.j. This distance is also the object's priority. The following contraction function may be used:

$${r}_{dj} = {r}_{d} ( 1 - {( \frac{c \cdot ‖ {\vec{r}}_{pj 1} ‖}{{r}_{d}} )}^{q} ) , \qquad ( Equation 35.1 )$$

where c is a free parameter that controls contraction linearly, and q is a free parameter that controls contraction exponentially.

The object priority, r_{dj}, is also used to determine if a tertiary virtual object 18.16.j.k should be visible in 10.2 and what the tertiary object's size should be. Such a function or algorithm may be:
Find the highest priority and make the corresponding tertiary object 18.16.j.k visible. Hide all other tertiary objects.
Increase the size of the visible tertiary object 18.16.j.k in proportion to the priority of secondary object 18.16.j.
Keep tertiary objects anchored to reference point 20.2.

With the pointer coordinates 12 located at the same position as reference point 20.1, the secondary objects 18.16.j are placed at constant radius r_{d} away from reference point 20.1 and at fixed angles θⱼ, while no tertiary visual objects 18.16.j.k are visible. FIG. 35.4 shows the pointer 14 moved towards object 18.16.3. The application of the algorithm and functions describe above, leads to the arrangements of objects 18.16, 18.16.j and 18,16.3.1 as shown in 10.2. Object 18.16.1 almost did not move, object 18.16.2 moved somewhat closer to object 18.16 and object 18.16.3 moved much closer. Tertiary visual object 18.16.3.1 is visible and becomes larger, while all other visual objects are hidden. When the threshold 23.16.3 is crossed, all objects except 18.16, 18.16.3 and 18.16.3.1 is removed from 10.1. The tertiary object takes over the available space in 10.2. FIG. 35.5 shows a further upward movement of the pointer 14 towards tertiary object 18.16.3.1. The tertiary object adjust its position so that if the pointer 14 moves towards the reference point 20.2, the object moves downwards, while if the pointer 14 moves away from reference point 20.2, the tertiary object moves upwards. FIG. 35.6 shows a further upward movement of pointer 14. The application of the algorithm and functions describe previously, leads to the arrangements of object 18,16.3.1 in 10.2 as shown. In this case, object 18,16.3.1 moved downwards, so that more of its child objects are revealed. Further thresholds and actions can be associated with the tertiary object's children.

Referring now to FIG. 36 and building on the methods, functions, algorithms and behaviour as described in FIG. 33, the method may further include the steps of determining coordinates of more than one pointer and establishing a relation between the pointers. The first pointer is denoted by 14.1 and the second pointer by 14.2. FIG. 36.1 shows the first pointer 14.1 in the neutral position with the pointer coordinates 12.1 coinciding with the pointer reference coordinates 20. The relative distances rᵢₚ between pointer 14.1's coordinates 12.1 and the interaction coordinates 17.i of interactive objects 18.i are equal. This means that the priorities of all interactive objects 18.i are also equal. The result is that the interactive objects 18 in 10.2 have the same diameter W, and that the display coordinates 16.i are equally spaced in a circle around the reference point 20. FIG. 36.2 shows the first pointer 14.1 displaced halfway between the reference point 20 and interactive object 18.1's interaction coordinates 17.1. The resultant object sizes and placements are shown in 10.2. The sizes of objects with higher priority (those closest to the pointer 14.1) are increased, while objects with lower priority are moved away from the pointer reference line. Note that the positions of the interaction 17 and display 16 coordinates are now different. FIG. 36.3 shows the first pointer 14.1 at the same location as before. A second pointer 14.2 with coordinates 12.2, is introduced near interactive object 18.10's interaction coordinate 17.10 in 10.1. The pointer 14.1, reference point 20 and pointer 14.2 form a pie segment in 10.1. Together with the mirror image (mirrored around the pointer reference line formed by reference point 20 and pointer 14.1) of the pie segment, a special region 70 is defined. This region 70 is updated as the pointers, 14.1 and 14.2, moves around, allowing the user to adjust the bounds of the defined region. When the second pointer 14.2 is removed, region 70 is captured. The interaction coordinates 17.i of interactive objects 18.i with display coordinates 16.i that falls within the region 70, is updated to the current display coordinate positions 16.i. All other interaction coordinates remain unchanged. In this example, the interaction coordinates of interactive objects 18.1, 18.2 and 18.12 are updated. If pointer 14.1 moves around in region 70, objects captured within region 70 remains static in 10.2. Objects outside of this region, 18.3 to 18.11 in this case, interact as described previously. It would also be possible to define new interaction rules to the interactive objects captured within region 70. If pointer 14.1 moves outside of region 70, the previously captured interaction coordinates 17.i of interactive objects 18.i reset to their initial positions and all objects interact again as described previously.

Referring now to FIG. 37 and building on the methods, functions, algorithms and behaviour as described in FIG. 28, a method for recursively navigating hierarchical data, with non-equal prior importance associated with each object in the data set, is demonstrated. A data set with some way of indicating relative importance, for example frequency of use, of one object over another is used. The initial sizes of the interactive objects in 10.1 are determined proportionally to its prior relative importance, so that more important objects occupy a larger segment of the annulus. The display coordinates 16.i, interaction coordinates 17.i, thresholds 23.i and object priorities are determined and calculated as before. FIG. 37.1 shows the initial arrangement of a first level of eight interactive objects, 18.1 to 18.8. The relative prior importance of 18.1 and 18.5 are the same, and of higher importance than the remaining objects, which also have the same relative prior importance. FIG. 37.2 shows the arrangement after the pointer moved as indicated by trajectory 42. As before, a second level of hierarchical items is introduced for the interactive objects with the highest priority, 18.1, 18.2 and 18.8 in this case. The new interactive objects, their display coordinates, interaction coordinates and thresholds are indicated by sub-numerals. Interactive object 18.1 is larger than 18.2 and 18.8, which in turn is larger than 18.3 and 18.7, which in turn is larger than 18.4 and 18.6. Note that object 18.5 is larger than 18.4 and 18.6, due to its higher relative prior importance. The visible second level of interactive objects 18.1.1-4, 18.2.1-4 and 18.8.1-4, are also sized according to their relative prior importance in the data set. As indicated, 18.1.1 is twice as important than 18.1.2, while 18.1.2 is twice as important as 18.1.3 and 18.1.4, which have the same relative prior importance. A function is assigned to the threshold 23 whereby an interactive object is selected and a next level for navigation is established, based on the selected object, when the threshold 23 is pierced, for example by crossing the perimeter of an object. As the pointer moves closer to a threshold 23, the highest priority interactive object takes up more space in the annular arrangement, until it completely takes over and occupies the space. This coincides with the highest priority item's threshold 23 being pierced. When the next level of navigation is established a new pointer reference point 20 is established at the pointer's location. For the selected interactive object, new interaction coordinates 17 and thresholds 23 are established for its children and updated as before. A new interactive object may be established to represent navigation back to previous levels. This object behaves in the same way as objects that represent data, but does not display child objects. FIG. 37.3 shows the initial arrangement, around new pointer reference point 20.2, of a second level of hierarchical objects, 18.1.1 to 18.1.4, after interactive object 18.1 has been selected. The interactive objects are sized according to their relative prior importance. As indicated, 18.1.1 is twice as important as 18.1.2, while 18.1.2 is twice as important as 18.1.3 and 18.1.4, which have the same relative prior importance. The new interaction coordinates 17.1.1 to 17.1.4 and thresholds 23.1.1 to 23.1.4 are indicated. An interactive object 18.1.B that can be selected to navigate back to the previous level, along with its associated display coordinates 16.1.B, interaction coordinates 17.1.B and threshold 23.1.B, are also shown. When 18.1.B is selected, an arrangement similar to that of FIG. 37.1 will be shown. As before, the interaction coordinates 17 and the positions of associated thresholds 23 don't change during navigation until one of the thresholds 23 is pierced and a new navigation level is established

It shall be understood that the examples are provided for illustrating the invention further and to assist a person skilled in the art with understanding the invention and are not meant to be construed as unduly limiting the reasonable scope of the invention.

1. A method for human-computer interaction on a graphical user interface (GUI), the method comprising:
determining coordinates of a pointer with, or relative, to an input device;
determining coordinates of interactive objects of which at least two objects are displayed;
establishing a threshold in relation to the interactive objects and in relation to space about them;
determining a priority value for each of the interactive objects in relation to their distance and/or direction to the pointer;
moving the interactive objects and thresholds relative to the priority values of the interactive objects;
repeating the above steps in response to a change in the coordinates of the pointer; and
performing an action when the threshold is reached.

2. The method as claimed in claim 1, wherein a highest priority is given to an interactive object closest to the pointer and a lowest priority is given to an interactive object furthest from the pointer.

3. The method as claimed in claim 1, wherein moving the interactive objects and thresholds relative to the priority vales of the interactive objects comprises:
determining new coordinates are calculated for the interactive objects that reduce a distance between interactive objects having a highest priority and the pointer and increase a distance between interactive objects having a lowest priority and the pointer.

4. The method as claimed in claim 2, wherein the interactive objects are sized relative to their priority value.

5. The method as claimed in claim 2, wherein interactive objects having lower priority values are moved away from interactive objects having higher priority values.

6. The method as claimed in claim 1, wherein determining coordinates of the pointer with, or relative, to the input device comprises:
determining a reference point for the pointer and determining coordinates relative to the reference point for the pointer.

7. The method as claimed in claim 6, further comprising:
repositioning the reference point for the pointer in response to the change in the coordinates of the pointer.

8. The method as claimed in claim 1, wherein the coordinates of the interactive objects are in accordance with a weights assigned to each object according to a prior relative importance of an interactive object and wherein coordinates of the interactive objects are determined relative to each other.

9. The method as claimed in claim 1, wherein determining the coordinates of the interactive objects comprises determining the coordinates of the interactive objects relative to each other.

10. The method as claimed in claim 1, wherein moving the interactive objects and thresholds relative to the priority values of the interactive objects comprises arranging the interactive objects so at least a plurality of directions from the pointer points at coordinates of a single interactive object.

11. The method as claimed in claim 6, wherein a distance between coordinates of an interactive object and the reference point for the pointer is used to determine a priority value for the interactive object.

12. The method as claimed in claim 1, further comprising:
recording the movements of the pointer to determine a trajectory of the pointer.

13. The method as claimed in claim 12, wherein the trajectory is used to determine an intended direction and/or speed of the pointer and/or time derivatives thereof, and determining the priority values for the interactive objects based at least in part on one or more selected from a group consisting of: the intended direction of the pointer, the speed of the pointer, a time derivative of the speed of the pointer, and any combination thereof.

14. The method as claimed in claim 12, further comprising:
determining an input relating to one or more of the interactive objects based at least in part on the trajectory.

15. The method as claimed in claim 1, wherein the interactive objects are arranged on a boundary of a convex space.

16. The method as claimed in claim 1, wherein distance between the pointer and an interactive object and a direction from the pointer to the interactive object are used to determine independent effects on the interactive object.

17. The method as claimed in claim 6, wherein establishing the threshold in relation to the interactive objects and in relation to space about them comprises establishing the threshold selected from a group consisting of:
a threshold related to an interactive object;
a threshold associated with space about an interactive object;
a threshold fixed in relation to the reference point for the pointer;
a threshold established in time, when the pointer coordinates remain static within certain spatial limits for a predetermined time; and
any combination thereof.

18. The method as claimed in claim 17, wherein, when the threshold is reached, the action comprises: modifying a visual representation of:
the pointer;
a displayed background; and
changing an interactive object.

19. The method as claimed in claim 17, wherein, a position or a shape of the threshold is changed dynamically in association with the interactive objects and relative to each other.

20. The method as claimed in claim 1 further comprising changing a state of an interactive object in relation to the position of the pointer relative to the interactive object.

21. The method as claimed in claim 1, wherein determining coordinates of the pointer with, or relative, to the input device comprises which includes the steps of determining coordinates for each of a plurality of pointers and establishing a relation between the plurality of pointers.

22. The method as claimed in claim 17, wherein establishing the threshold in relation to the interactive objects and in relation to space about them comprises: establishing a threshold associated with space proximate to an interactive object and further comprising establishing new interactive objects belonging logically in or behind space between existing interactive objects when the threshold is activated.

23. A method for human-computer interaction on a graphical user interface (GUI), the method comprising:
determining coordinates of a pointer;
arranging interactive objects in a convex collection configuration relative to the pointer or to a center point;
displaying one or more of the interactive objects in the convex collection;
determining coordinates of the interactive objects displayed on the GUI relative to the coordinates of the pointer;
determining priority values for each of the interactive objects based at least in part on their distances to the pointer; and
moving the interactive objects relative to their priority values.

24. The method as claimed in claim 23, wherein determining coordinates of the interactive objects displayed on the GUI relative to the coordinates of the pointer comprises:
determining interaction coordinates of one or more interactive objects;
determining display coordinates of the interactive objects of which at least two objects are displayed on the GUI.

25. The method as claimed in claim 23, wherein displaying one or more of the interactive objects in the convex collection comprises arranging the interactive objects such that a plurality of directions from the pointer points at a single interactive object.

26. The method as claimed in claim 25, wherein the interactive objects are arranged in the convex collection to provide a functional advantage to a user interacting with the interactive objects.

27. The method as claimed in claim 24, wherein a threshold is established relating to an interaction coordinate of an interactive object, the threshold associated with space proximate to the interaction coordinate of the interactive object.

28. A method for human-computer interaction on a graphical user interface (GUI), the method comprising:
referencing a point in a virtual space at which a user is navigating at a point in time, called the pointer;
referencing points in the virtual space;
calculating interaction of the points in the virtual space with the pointer in the virtual space according to an algorithm whereby distance between points closer to the pointer is reduced;
establishing a threshold in relation to the referencing points and in relation to space about them;
modifying reference point thresholds based at least in part on distance between the reference point and the pointer;
and
performing an action when the threshold is reached.

29. A method as claimed in any one of claim 28, further comprising:
assigning a virtual z coordinate value to interactive objects displayed on the GUI, to create a virtual three-dimensional GUI space extending behind and/or above a display;
determining a corresponding virtual z coordinate value relative to the distance, Z, of a pointer object above an input device; and
establishing a virtual threshold related to the virtual z coordinate value in the z-axis, the Z coordinate of the pointer object being related to the virtual threshold.

30. The method as claimed in claim 29, wherein a new virtual threshold plane is established in response hovering the pointer object for a predetermined time after the pointer corsses a virtual threshold plane.

31. The method as claimed in claim 29, further comprising providing a plurality of virtual threshold planes along the z-axis, each providing a plane in which to arrange interactive objects in the GUI.

32. The method as claimed in any one of claim 29, further comprising changing a visual representation of the pointer based at least in part on its position along the z-axis.

33. The method as claimed in claim 29, further comprising determining an orientation or a change of orientation of the pointer object above an a fixed set of coordinates on the input device.

34. A computer program product comprising a computer readable storage medium having instructions encoded thereon that, when executed by a processor, cause the processor to:
determine coordinates of a pointer relative to an input device;
determine coordinates of interactive objects of which at least two objects are displayed by a display;
establish a threshold in relation to the interactive objects and in relation to space about them;
determining priority values for each of the interactive objects based at least in part on their distances to the pointer;
move the interactive objects and the based at least in part on the prority values for various interactive objects; and
perform an action when the threshold is reached.

35-39. (canceled)
